(19) United States
(12) Patent Application Publication
(10) Pub. No.: US 2012/0063597 A1
(43) Pub. Date: Mar. 15, 2012

(54) APPARATUS AND ASSOCIATED METHODOLOGY FOR MANAGING CONTENT CONTROL KEYS

(75) Inventors: Lawrence B. Tropp, Wilmette, IL (US); Thomas R. Volpert, Chicago, IL (US)

(73) Assignee: UPONUS TECHNOLOGIES, LLC., Wilmette, IL (US)

(21) Appl. No.: 12/882,431

(22) Filed: Sep. 15, 2010

(51) Int. Cl. H04L 9/00

(52) U.S. Cl. 380/259

(57) ABSTRACT

A method of exchanging secret session keys in symmetric encryption communication includes storing random number tables in both the sending and receiving devices. The sending device then determines the secret session key utilizing the random number table, and transmits to the receiving device information for locating the secret session key within the random number table. Thus, the sending device shares the secret session key with the receiving device without actually transmitting the secret session key. The random number tables may be transmitted from one device to the other or be preinstalled in each device. Further, a common seed value may be used by each device to generate the random number table independently.

The present advancements relate generally to encryption and decryption, and, more particularly, to generation and distribution of secret session keys used for encryption and decryption in a symmetric key encryption system.

### BACKGROUND

As society's demand for greater amounts of digital information grows, so do the demands on the system of sharing and distributing that information. With such increases in information distribution comes the risk that the information will be stolen, illegally copied and distributed or otherwise used by unauthorized persons. Demand for methods to secure the data during distribution have also grown to safeguard against these risks, and the search for new or improved security and/or cryptographic methods to protect has consequently increased. The demand for new, more sophisticated security methods will only continue to rise with the ever increasing news accounts of hacked or stolen data.

One method of securing data that is being distributed is through symmetric key encryption. In a typical symmetric key encryption system, a sender encrypts the digital data with a secret session key thereby obscuring or “mangling” the digital data before transmission. A receiver, upon receiving the encrypted digital data from the sender, uses the same secret session key to decrypt the digital data back into its original form so that it can be used.

Careful consideration is often given to the structure and values forming the secret session key. Secret session keys must be a seemingly random, unique combination of values to deter cryptographic attacks, such as dictionary attacks where lists of probable phrases, keywords and/or values are systematically tried on the encrypted data in an effort to obtain the secret session key itself. The secret session key must also be a relatively large, combination of values to overcome computational attacks based on trying many different value combinations in order to identify which combination is the secret session key.

In symmetric key encryption, both the sender and receive must have a copy of the same secret session key and encryption algorithm in order to encrypt and decrypt the transmitted data. Many times this means that the sender must also send a copy of the secret session key to the receiver in addition to the encrypted data. In a conventional secret session key exchange, the secret session key is encrypted with any number of conventional cryptographic key exchange methods. However, all conventional systems must transmit the entire secret session key from the sender to the receiver during the exchange. Therefore, a risk exists that a third party, such as an intruder, opponent, hacker and the like, may intercept the key transmission and acquire the secret session key. To mitigate this risk, conventional systems employ strong encryption schemes to protect the secret session key.

Further, conventional systems use a great deal of resources to authenticate all parties to a transmission (i.e. sender and receiver) using a variety of methods, and frequently on a repeated basis, by issuing challenges and testing the responses among the parties before the secret session key is transmitted or secured data exchange is begun. However, transferring the secret session key from the sender to the receiver remains the weakest link in conventional cryptographic systems because it exposes the secret session key to interception and possible decryption by unintended and/or nefarious parties.

### SUMMARY

The present advancements address the vulnerability of the secret session key during transfer from the sender to the receiver in a symmetric key encryption scheme. In one exemplary embodiment, a method of creating and exchanging secret session keys for symmetric secret key encryption between the sending device and the receiving device does not transmit the actual secret session key between the sending and receiving devices. The method begins by providing the receiving device with a unique device number, a unique user keycode number and a symmetric secret key encryption algorithm. The sending device is provided with the symmetric secret key encryption algorithm, a seed value and a non-system randomizer to generate a predetermined number of pseudo-random bit data based on the seed value, which is then arranged into a random number table and stored in an electronic memory of the sending device. The receiving device transmits both the unique device number and the user keycode number through secure communication to the sending device. Then the sending device assigns the random number table to the unique device number and the user keycode number received from the sending device. The assignment is stored in a secret index in the electronic memory. The sending device then selects a secret session key as a subset of the pseudo-random bit data in the random number table, and assigns a start pointer corresponding to the start of the subset and an end pointer corresponding to the end of the subset. Selected properties of the secret session key, such as length and location in the random number table are determined and stored along with the start and end pointers in a secret session key properties descriptor buffer at the sending device. The subset of pseudo-random bit data is also copied to a secret session key buffer of the sending device as the secret session key. Copying of the pseudo-random bit data is performed by using the start and end pointers. The contents of the secret session key properties descriptor buffer are then transformed into mangled secret session key properties. The data to be transmitted is stored in the input/output buffer of the sending device, and then encrypted using the secret session key and the symmetric key encryption algorithm. The contents of the secret session key properties descriptor buffer, and the user keycode number, are then appended to the encrypted data as a header. A connection between the sending device and the receiving device is created, and the encrypted content with the appended header are transmitted from the sending device to the receiving device. The receiving device then compares the transmitted user keycode number to a user keycode stored therein to determine whether the receiving device is authorized to decrypt the encrypted contents. The receiving device then extracts the mangled session key properties and stores them in a mangled secret session key properties descriptor buffer when authorized to decode the data. The mangled session key properties are restored, and the start and end pointers are used to determine the secret session key from the receiving device's copy of the random number table. The encrypted content is then decrypted with the secret session key and the symmetric key encryption algorithm, and the receiving device then reads, uses or plays the contents, and communication between the sending device and the receiving device is maintained until one or both devices terminate the session.

### BRIEF DESCRIPTION OF THE DRAWINGS

A more complete appreciation of the embodiments described herein, and many of the attendant advantages thereof, will be readily obtained as the same becomes better understood by reference to the following detailed description when considered in connection with the accompanying drawings, wherein:

FIG. 1 is a schematic drawing of a communications system according to an exemplary embodiment of the present advancements;

FIG. 2 is a schematic drawing of a communication device according to an exemplary embodiment of the present advancements;

FIG. 3 is a functional block diagram of the communication device according to an exemplary embodiment of the present advancements;

FIG. 4 is a flowchart of one-way communication between two devices according to an exemplary embodiment of the present advancements;

FIG. 5 is a flowchart of the algorithmic process executed by the sending device in one-way communication according to an exemplary embodiment of the present advancements;

FIG. 6 is a flowchart of the algorithmic process executed by a receiving device in one-way communication according to an exemplary embodiment of the present advancements;

FIG. 7 is a flowchart of random number table exchange according to an exemplary embodiment of the present advancements;

FIG. 8 is a flowchart of seed value exchange according to an exemplary embodiment of the present advancements;

FIG. 9 is a flowchart of random number table generation in the receiving device using the exchanged seed value according to an exemplary embodiment of the present advancements;

FIG. 10 is a flowchart of two-way communication according to an exemplary embodiment of the present advancements;

FIG. 11 is a flowchart of the algorithmic process executed by the sending device in two-way communication according to an exemplary embodiment of the present advancements; and

FIG. 12 is a flowchart of the algorithmic process executed by a receiving device in two-way communication according to an exemplary embodiment of the present advancements.

### DETAILED DESCRIPTION

Referring now to the drawings, wherein like reference numerals designate identical or corresponding parts throughout the several views, the claimed advancements relate to methods of exchanging secret session keys in symmetric encryption without transmitting the actual secret session key from the sending device to the receiving device. Instead, each devices stores an identical random number table from which the secret session key is selected. The sending device then selects the secret session key from its random number table, and transmits to the receiving device information describing the location of the secret session key within the random number table, thereby sharing the secret session key with the receiving device without actually transmitting the secret session key to the receiving device. The random number tables stored in the sending and receiving devices may be preloaded in each device, or may transmitted from the sending device to the receiving device in a one-time secure transmission. In lieu of sending the entire random number table, the sending device may transmit a seed value to the receiving device, which the receiving device can use to generate its own identical copy of the random number table stored in the sending device. Sharing of random number tables between the sending device and the receiving device is described below in detail.

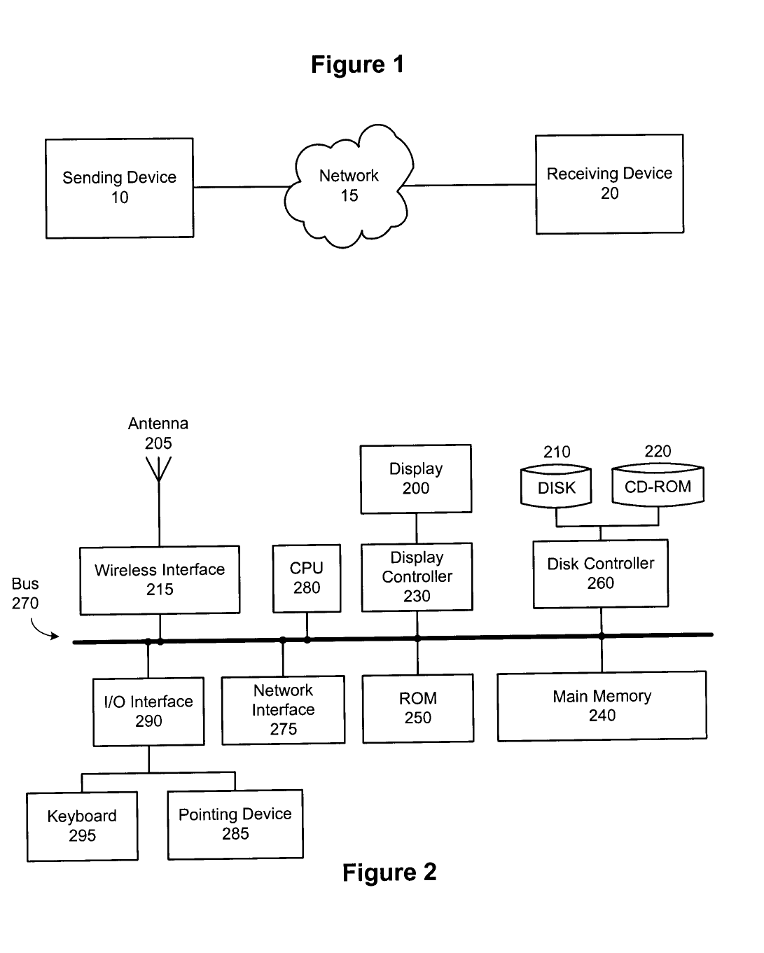

FIG. 1 is a schematic drawing of a communications system according to an exemplary embodiment of the present advancements. In FIG. 1, a sending device 10 is connected to a receiving device 20 via a network 15. For example, one or both of the sending device 10 and the receiving device 20 may be personal computers, laptop computers, netbook computers, smart phones, or personal digital assistants. The network 15 may be a wired network, such as an LAN network, PSTN network, ISDN network or may be a wireless network, such as a cellular network, Blue Tooth network, WiFi network or any other wireless network known in the art. Further, network 15 may also be a private network or a public network, such as the Internet, or any combination thereof. Of course, as one of ordinary skill in the art would recognize, different network architectures and topologies may be embodied by the inventive system and concepts described herein without departing from the scope of the present advancements.

As used herein, a sending device is a device that initiates, and controls the communication session with one or more additional devices. The receiving device is a device with which one or more sending devices communicate. However, both the sending device and the receiving device are able to transmit and receive data.

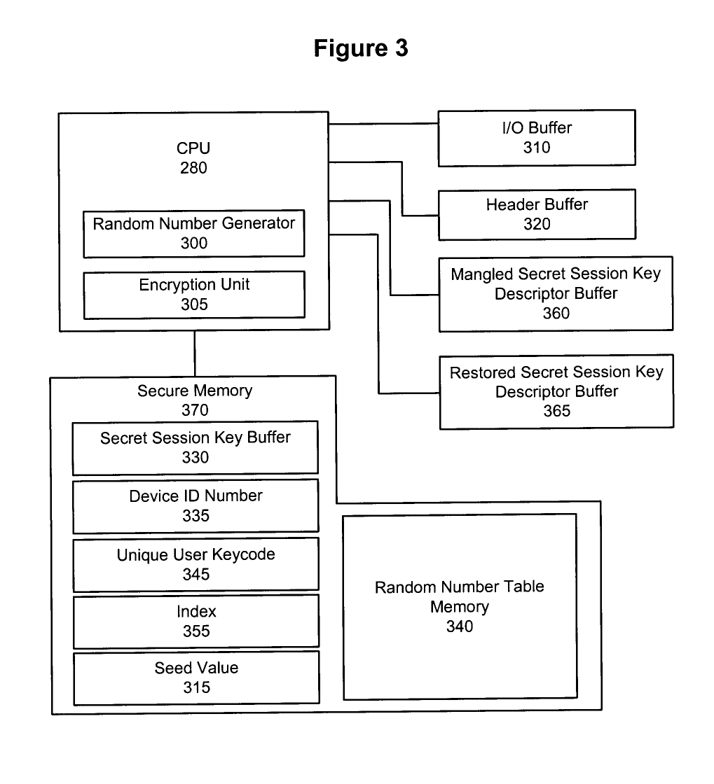

FIG. 2 is a block diagram of the hardware of a device according to exemplary embodiments. As one of ordinary skill in the art would recognize, the descriptions provided below with respect to FIG. 2 are applicable to both the sending device 10 and the receiving device 20. In FIG. 2, the device includes a CPU 280 which processes data and instructions stored in main memory 240 and/or ROM 250. The CPU 280 also processes information stored on the disk 210 or CD-ROM 220. Thus, instructions corresponding to the process for managing content control keys as described below, may be stored on any one of disk 210, CD-ROM 220, main memory 240, ROM 250 or stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk, or any other information processing device with which the sending or receiving device communicates, such as a server or computer.

CPU 280 may be Xenon processor from Intel of America or an Opteron processor from AMD of America, or may be other processor types, such as a Freescale ColdFire, IMX or ARM processor from Freescale Corporation of America. Alternatively, the CPU 280 may be a processor such as a Core 2 Duo from Intel Corporation of America, or may be implemented on an FPGA, ASIC, PLD or using discrete logic circuits, as one of ordinary skill in the art would recognize.

The device in FIG. 2 also includes a network interface 275, such as an Intel Ethernet PRO network interface card from Intel Corporation of America, for interfacing with the network 15; a display controller 230, such as a NVIDIA GeForce GTX graphics adapter from NVIDIA Corporation of America for interfacing with a display 200, such as a Hewlett Packard HP L2445w LCD monitor. An I/O interface 290 interfaces with a keyboard 295 and a pointing device 285, which may be a roller ball or mouse, for example.

Disk controller 260 connects disk 210, such as a hard disk drive or FLASH memory drive, and CD-ROM 220 or DVD drive with bus 270, which may be an ISA, EISA, VESA, PCI, or similar for interconnecting all of the components of the device. A description of the general features and functionality of display 200, keyboard 295 and pointing device 285, as well as the display controller 230, disk controller 260, network interface 275, and I/O interface 290 is omitted herein for brevity as these features are well known.

In FIG. 2, the device also includes a communication interface 215 and antenna 205 to communicate with other devices wirelessly. For example, the communication interface 215 and antenna 205 may be used to communicate with a smart phones, such as an iPhone® from Apple, Inc. of America or a Droid® from Motorola Corporation of America. Further, the device of FIG. 2 itself may also be a mobile device, such as a smart phone. As such, the communication interface 215 may communicate with other devices via a cellular network (including EDGE, 3G, 4G, etc.), WiFi, BlueTooth, or any other wireless form of communication that is known. As can be appreciated, the hardware description given above with respect to FIG. 2 is merely exemplary and other hardware configurations are possible without departing from the scope of the present advancements.

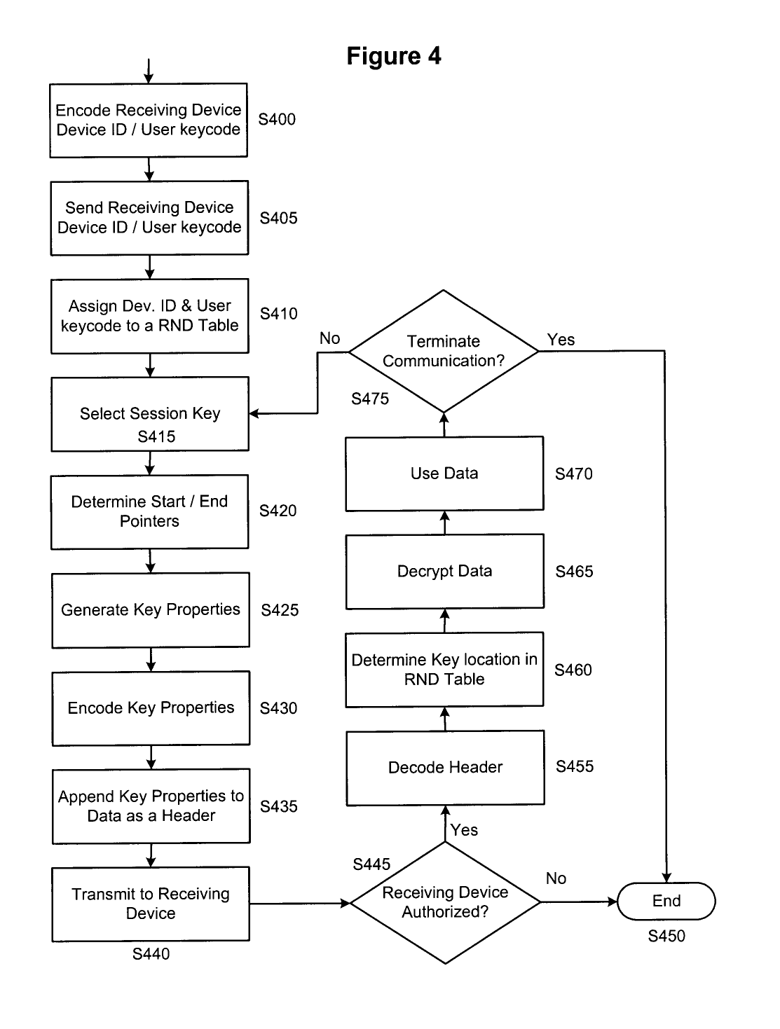

FIG. 3 is a functional block diagram of the device in FIG. 2, which can be either the sending device 10 or the receiving device 20. In FIG. 3, the CPU 280 includes an encryption unit 305 that both encrypts and decrypts data according to a symmetrical key encryption algorithm. The CPU 280 uses the encryption unit 305 to encrypt and decrypt data communicated to and from other devices using a secret session key generated according to exemplary embodiments of the present advancements. As can be appreciated, any symmetric key encryption algorithm may be used without departing from the scope of the present invention.

The random number generator 300 is used to generate pseudo-random bit data that is organized into a random number table, as described below in detail. A seed value 315 is provided to the random number generator 300 in order to generate the pseudo-random bit data, such that different seed values 315 will cause the random number generator 300 to generate different bit value streams. Further, if the same seed value 315 is provided to the random number generators 300 of two devices, both random number generators will generate the same bit value stream. As one of ordinary skill in the art would recognize any random number generating algorithm may be used without departing from the scope of the present advancements.

The device in FIG. 3 also includes a secure memory 370 connected to the CPU 280. Secure memory 370 is secure in that it may be secret, i.e. not viewable by a user of the device, or may have restricted access. The secure memory 370 includes a secret session key buffer 330 to store a secret session key used by the encryption unit 305; a unique device number, or device ID number 335; a unique user keycode 345 and an index 355. The secure memory 370 also includes a random number table memory 340 that stores the random number table described in detail below, and is connected through the secure memory 370 to the CPU 280. An input/output buffer 310 receives data transmitted from other devices and also temporarily holds data to be transmitted to other devices. Header buffer 320, mangled secret session key descriptor buffer 360 and restored secret session key descriptor buffer 365 store and manipulate secret session key properties as described in detail below. In FIG. 3, only one secret session key buffer 330 and one random number table memory 340 are illustrated. However, as one of ordinary skill in the art would recognize, multiple secret session key buffers and random number tables are possible to allow for communication with multiple devices independently. Further, the functional memories and buffers described above may reside in any one of main memory 240, disk 210 and/or CD-ROM 220. Therefore, FIG. 3 is merely exemplary and does not limit the scope of the present advancements.

Prior to performing the encryption/decryption methods described in detail below, both the sending device 10 and the receiving device 20 must share preliminary information for establishing the secure communication, and must therefore authenticate each other. The sending device 10 and the receiving device 20 must also share the same symmetric key encryption algorithm. Among the information shared between the sending device 10 and the receiving device 20 during authentication in preparation for secure communication are each device's own unique device number and each device's own unique user keycode number. The unique device number of each device may be used as part of the methods for establishing trusted communication links and authenticity verification between the sending device 10 and the receiving device 20.

In order to begin any communication, the sending device 10 and the receiving device 20 participate in the same channel communication, for example over the Internet using a common and shared protocol such as TCP/IP or FTP. Then the devices immediately utilize and satisfactorily complete the same methods and processes for establishing trusted communication links and authenticity verifications between the devices prior to sharing secret information in any secured communication with each other. Such methods are known and are therefore not discussed further herein for brevity.

As discussed above, each exemplary device possesses certain types of unique data in common, such as unique device numbers and unique user keycode numbers. The unique device number of each device may be used as part of the methods for establishing trusted communication links and authenticity verification between the devices early on in the process. Once the communication link and authenticity is verified, secure communication according to the present advancements begins using random number tables as described below. The random number table, or any portion thereof, may be transmitted from the sending device 10 to the receiving device 20, or a seed value 315 may be transmitted from the sending device 10 to the receiving device 20 so that the receiving device 20 can generate its own version of the random number table internally. In addition, the same random number table can be preloaded into each device, such as during manufacture. As can be appreciated, any method can be used to provide the same random number table to each of the sending device 10 and the receiving device 20 without departing from the scope of the present advancements.

Next, the random number tables used in the present advancements are described in detail. The random number tables in the random number table memory 340 of both the sending device 10 and the receiving device 20 are the source from which secret session keys are selected to encrypt data that is to be transmitted and received securely using symmetric key encryption. Random number tables are created and/or made available to each device in one of three ways: the random number tables may be preloaded and installed in the random number table memory 340 of each device; the random number tables may be generated as needed by the sending device 10 and then securely communicated as an exact replica to the receiving device 20; or each device may generate its own version of the random number table using a same seed value 315 that is securely communicated therebetween. In the latter, the sending device 10 securely communicates the seed value 315 to the receiving device 20. In a further embodiment, the random number tables may also be shared between devices.

When one or more random number tables are preloaded into each device, the random number tables can be preloaded at a manufacturing facility, a retailer or may be downloaded from a network server. Also, previously used random number tables can be utilized again by the same devices to select different secret session keys for continuing secured communications. In negotiations between the sending device 10 and the receiving device 20 via a trusted communication link the random number table to be used can be decided by referring to the appropriate table using a user keycode number 345 assigned to the random number table and stored in each device with the corresponding random number table.

In addition, the same random number table may also be assigned to more than one unique device number 335 corresponding to more than one receiving device 20, but may only be assigned to a single user keycode 345. Therefore, each replica of a random number table stored at each separate receiving device 10 corresponds to a unique receiving device number 335 and unique user keycode number 345 pair assigned to the random number table. Alternatively, each user of a receiving device 20 may be assigned to multiple, separate user keycode numbers 345, which are each assignable to a separate, unique random number table having a single receiving device number 335 stored in an index 355 in correspondence to the receiving device 20. When a receiving device 20 is assigned to numerous uniquely generated random number tables, each corresponding to a separate unique user keycode number 345, that receiving device 20 can have multiple relationships with multiple sending devices 10 or at least more choices for selecting a secret session key from amongst the many random number tables stored assigned thereto. The sending device 10 may also accommodate the receiving device 20 by using a random number table and user keycode number 345 assigned to the receiving device 20 as the source for selection of a secret session key. All random number tables and their corresponding unique device numbers 335 and corresponding user keycode numbers 345 are stored in an index 355 at the sending device 10.

Next, a one-way communication method between the sending device 10 and the receiving device 20 across network 15 is described with reference to FIG. 4. At step S400, a unique device number (device ID) 335 and user keycode number 345 are assigned to the receiving device 20 prior to the start of secure communication with the sending device. At step S405, the receiving device 20 sends both the unique device number 335 and the user keycode number 345 to the sending device 10. At step S410, the sending device 10 assigns the unique device number 335 and the user keycode number 345 received from the receiving device 20 to a random number table.

Once the random number table has been assigned to a unique device number 335 and the user keycode number 345, the sending device 10 selects a secret session key from the random number table at step S415. Then, the sending device 10 determines the start pointer and the end pointer, which define a location of the secret session key within the random number table at step S420. At step S425, the sending device 10 also generates key properties which further identify the secret session key within the random number table. For example, such key properties include a length of the secret session key, an offset with respect to the first entry in the random number table, an offset with respect to the last entry of the random number table. In addition the key properties may define the key as including every other table entry within the start and end pointers, every second entry within the start and end pointer, or any other method of selecting numbers from a table that is known. As such, neither the start and end pointers, nor the key properties in any way limit the scope of the present invention.

Once the key properties are selected, the key properties are encoded at step S430. Such encoding may include performing an exclusive-or operation between the key properties and, for example, the user keycode number 345, or may include encryption of the key properties using the encryption unit 305. As one of ordinary skill in the art would recognize, other methods of encoding or otherwise securing the key properties are also possible. For example, a separate encryption unit (not shown) implementing asymmetric encryption or RSA encryption may be used to encode, or transform, the key properties. Therefore, the method used to encode or secure the key properties does not limit the scope of the present advancements.

The encoded key properties are then appended as a header to the data to be transmitted to the receiving device 20 at step S435. At step S440, secure communication between the sending device 10 and the receiving device 20 is established, and the encrypted data with the appended header is transmitted from the sending device 10 to the receiving device 20.

The received data is then placed in the input/output buffer 310 of the receiving device 20. At step S445, the receiving device 20 determines whether it is authorized to decode the key properties by determining whether the user keycode number 345 transmitted from the sending device 10 matches a user keycode number 345 stored in the receiving device 20. If these values do not match, the communication abruptly ends at step S450. However, if the user keycode number values match, the receiving device 20 decodes the header of the received data using any one of the decoding and/or decrypting methods described above at step S455 and places the decoded key properties in restored secret session key descriptor buffer 365. Then, the receiving device 20 uses the decoded key properties to determine a location of the secret session key within a random number table stored in the random number table memory 340 at step S460 which is copied to the secret session key buffer 330. The random number table stored in the random number table memory 340 of the sending device 10 matches the random number table stored in the random number table memory 340 of the receiving device 20, such that identifying the secret session key in a predetermined location in either table yields the exact same secret session key.

At step S465, the receiving device 10 decrypts the encrypted data in the input/output buffer 310 using the secret session key stored in the secret session key buffer 330, and at step S470 the data is used by the receiving device 20. At step S475, the receiving device 20 determines whether additional communication is needed or whether the communication session can end. If the communication session can end, the receiving device 20 terminates communication at step S480. Otherwise, the process reverts to step S415 and continues until the devices determine that communication should end.

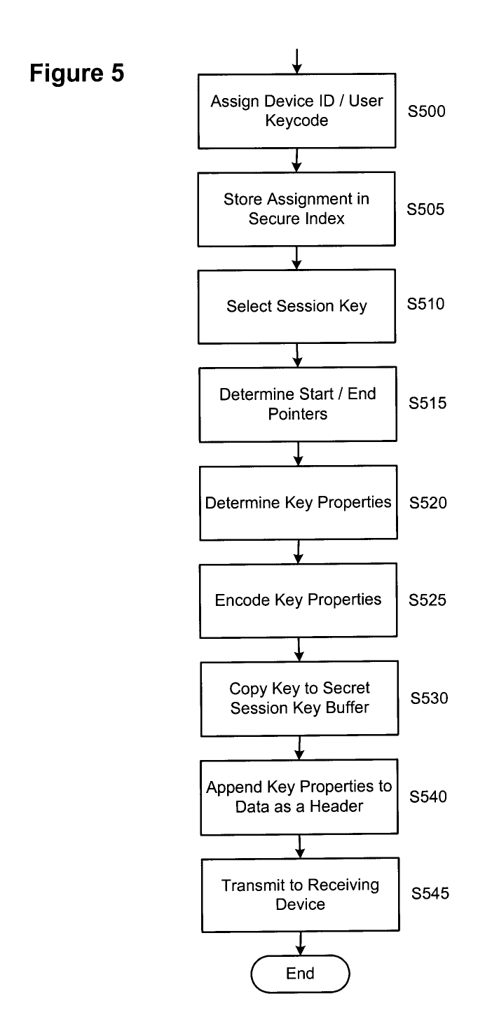

Next, the one-way communication process of the sending device 10 is described in detail with reference to FIG. 5. In FIG. 5, the sending device 10 begins by assigning the unique device number 335 and the user keycode number 345 of the receiving device 20 to a random number table stored in the random number table memory 340 at step S500. Then, the sending device 10 stores the assignment data in index 355 of secure memory 370. As discussed above, this secure memory 370 may be memory with restricted access and/or that is transparent to a user.

At step S510, the sending device 10 selects the secret session key. Then, the sending device 10 determines the start and end pointers within the random number table that specify the location of the secret session key at step S515. The sending device 10 also determines the key properties based on the start and end pointers at step S520. At step S525, the sending device 10 encodes the key properties using the user keycode number 345 and either an exclusive-or operation or encryption unit 305, as discussed above.

The sending device 10 also copies the secret session key to a secret session key buffer 330 at step S530. At step S540, the encoded key properties are appended to the data that will be transmitted to the receiving device 20, and the data is encrypted using the secret session key. Then, the sending device 10 transmits the encrypted data with the appended header to the receiving device 30 at step S545, and ends at step S550.

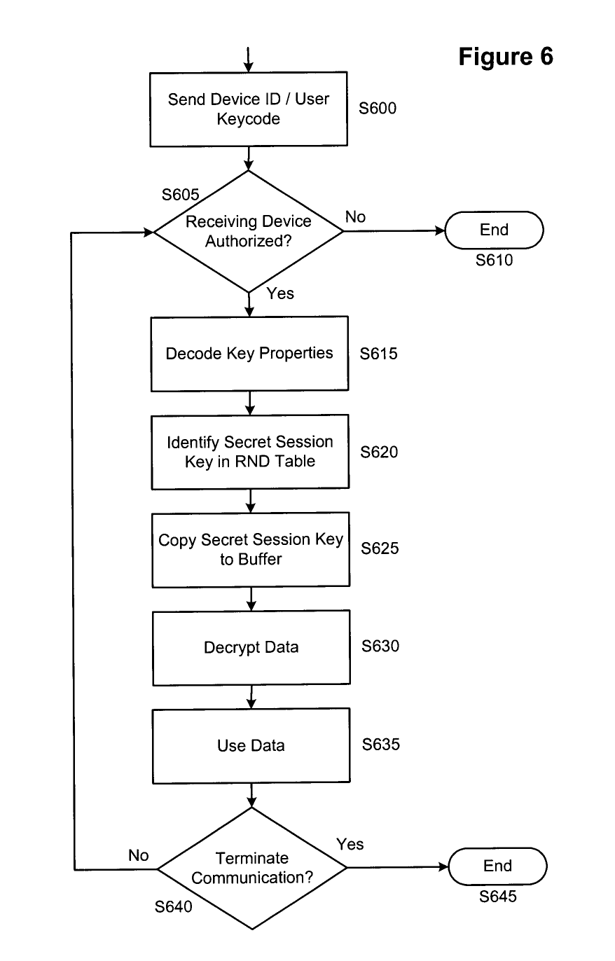

FIG. 6 is a flow chart of the process within the receiving device 20 during one-way communication with the sending device 10. In FIG. 6, the receiving device 20 first sends its unique device number 335 and user keycode number 345 to the sending device 10 at step S600. Then, upon receipt of a transmission from the sending device 10, the receiving device 20 determines whether it is authorized to decode the transmission at step S605. If the receiving device 20 determines that it is not authorized to decode the transmission, the communication ends at step S610. Otherwise, the receiving device proceeds to step S615 in which the key properties, which have been stored in the mangled secret session key descriptor buffer 360 are decoded.

The receiving device 20 determines whether it is authorized to decode the transmission by comparing its own, stored user keycode number 345 with a user keycode number included in the transmission from the sending device 10. If there is a match, then the receiving device 20 is authorized to decode the transmission. Otherwise, it is not.

At step S620, the receiving device 20 uses the decoded key properties, now stored in the restored secret session key descriptor buffer 365 to identify the secret session key within a random number table stored in the random number table memory 340. The random number table stored in the random number table memory 340 of the receiving device 20 is the same as the random number table stored in the random number table memory 340 of the sending device 10, such that the secret session key will be in the same location on both tables.

Once the receiving device 20 identifies the secret session key, the receiving device 20 copies the secret session key to the secret session key buffer 330 at step S625. At step S630, the receiving device 20 decrypts the transmitted data using the secret session key stored in the secret session key buffer 330. Then, at step S635, the receiving device 20 uses the decoded data. If, at step S640, the receiving device 20 determines that communication should end, communication ends at step S645. Otherwise, the process continues by reverting back to step S605 until either the sending device 10 or the receiving device 20, or both, determine that communication should end.

As noted above, prior to the secure communication described above, the random number table must be provided to both the sending device 10 and the receiving device 20. When a random number table is to be transmitted between sending device 10 and the receiving device 20, it is a process in common between the devices that occurs just once between the devices. Furthermore, this process is done in a secure manner after the devices have established trusted communication links and verified each other's authenticity. Successfully sharing random number tables secretly allows secure, continuous or multiple communications between the devices even over unsecured or public connections in accordance with the advancements described herein.

Sharing the actual random number table also requires ensuring a safe and complete transfer of an exact replica of the random number table from the sending device 10 to the receiving device 20. This sharing process begins by the receiving device 20 first transmitting secretly, over a secure communication link, its unique receiving device number 335 and a user keycode number 345 not assigned to a random number table. If there are no unassigned user keycode numbers available then additional ones are created or provided to the receiving device 20 secretly, over a secure communication link, before sharing of the random number table.

After the receiving device 20 has successfully transmitted secretly, over a secure communication link, its available user keycode number 345 to the sending device 10, it is assigned to the random number table in an index 355 at the sending device 10 corresponding to the unique device number of the receiving device 20. Then if the devices have established trusted communication links and verified the authenticity of each other, the sending device 10 communicates securely and secretly the actual assigned random number table to the receiving device 20, which stores it in the index 355 of secure memory 370 with its corresponding assigned unique user keycode number 345.

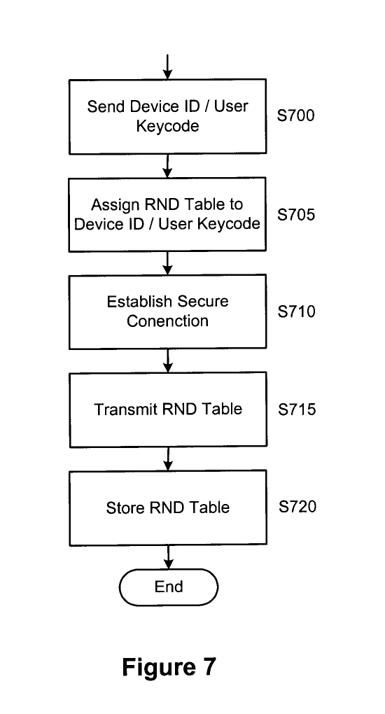

FIG. 7 is a flowchart of random number table transmission from the sending device 10 to the receiving device 20. In FIG. 7, the receiving device 20 transmits the unique device number 335 and user keycode number 345 in step S700 as discussed above. At step S705, the sending device 10 assigns the unique device number 335 and user keycode number 345 to a random number table stored in the random number table memory 340 of the sending device 10. In step S710, a secure communication is established between the sending device 10 and the receiving device 20. For example, such secure communication may include establishing a secure socket layer (SSL) connection, a IP security (IPsec) connection or any other secure connection known in the art. Once the connection is established, the random number table assigned to the unique device number 335 and user keycode number 345 is transferred from the sending device 10 to the receiving device 20 at step S715. Transmission of the random number table may include transmitting the entire table from one device to another, or transmitting any portion thereof. The receiving device 20 then stores the transmitted table in random number table memory 340. This table exchange is performed only once when the two devices first establish communication, and table exchange is not necessary again unless and until one or both of the devices desire to use a new table.

As discussed previously, the devices must share certain processes in common before communicating. In another exemplary embodiment each device separately generates the same random number table as the source from which secret session key(s) is selected. In this embodiment, each device includes the same random number generator 300 and share the same seed value 315 for the random number generator 300. Sharing the seed value 315 requires a safe and complete transfer of the exact seed value 315 from the sending device 10 to the receiving device 20. The sharing process begins by the receiving device 20 transmitting secretly, over a secure communication link, its unique device number 335 and a user keycode number 345 not assigned to a random number table. If no unassigned user keycode numbers are available, additional ones are created or provided to the receiving device 20 secretly, over a secure communication link, before this sharing process of the seed value can begin again.

After the receiving device 20 has successfully transmitted secretly, over a secure communication link, its available user keycode number 345 to the sending device 10, the sending device 10, using the seed value 315 in conjunction with the random number generator 300, creates an appropriate random number table and assigns it to the user keycode number 345 transmitted from the receiving device 20. The sending device 10 also stores the user keycode number 345 in an index 355 in correspondence to the unique device number 335 and the seed value 315. Then while the devices have established trusted communication links and verified the authenticity of each other, the sending device 10 securely and secretly communicates the seed value 315 to the receiving device 20, which uses it in conjunction with an identical random number generator 300 as the one used by the sending device 10 to create an identical random number table assigned to the user keycode number 345 stored in an index 355 at the receiving device 20 in correspondence to the unique user keycode number 345 and the seed value 315.

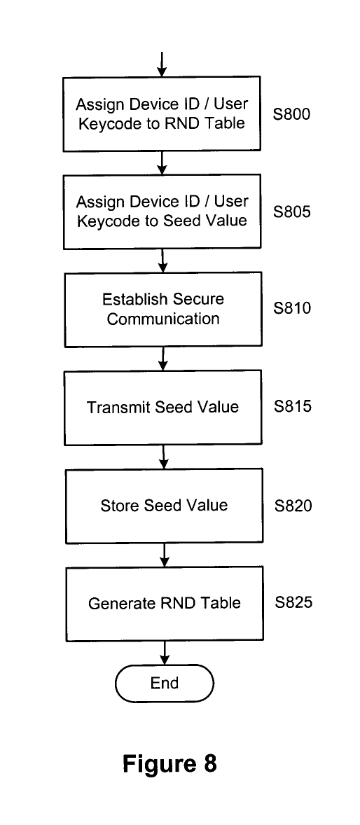

In FIG. 8, a method of exchanging seed values 315 used to generate the random number table is described. At step S800, the unique device number 335 and user keycode number 345 of the receiving device 20 is sent from the receiving device 20 to the sending device 10 as described above. Then, also as described above, the sending device 10 assigns the unique device number 335 and user keycode number 345 to a specific seed value 315. The seed value 315 is used by the sending device 10 to generate the random number table from which secret session keys will be extracted to communicate with the receiving device 20.

At step S810, the sending device 10 opens a secure communication channel with the receiving device 20. Then, at step S815, the sending device 10 sends the seed value 315 to the receiving device 20. At step S820, the receiving device stores the seed value 315 in secure memory 370 and at step S825 the receiving device 20 generates the random number table using the same random number generation algorithm used by the sending device 10.

As one of ordinary skill in the art would recognize, the sending device 10 and/or the receiving device 20 may generate the entire random number table and store the same in the random number table memory 340, or may generate only enough random number values to encompass the locations identified by the start and end pointers of the secret session key. Further, the sending device 10 and/or the receiving device 20 may generate the random number table each time a new secret session key is to be identified, and then delete the generated table once the secret session key has been extracted and saved to the secret session key memory 330. As such, the present advancements are not limited by the method used to generate the random number table.

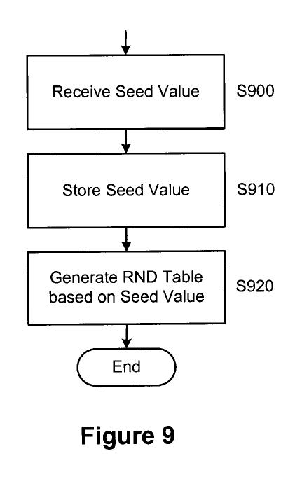

FIG. 9 is flowchart of table generation using a seed value In FIG. 9, the receiving device 20 receives the seed value 315 used to generate the random number table from the sending device 10 at step S900. At step S910, the receiving device 20 stores the seed value 315 in association with both the unique device number 335 and the user keycode number 345 in an index 355. This allows the receiving device 20 to store multiple seed values for communication with multiple sending devices.

At step S920, the receiving device 20 generates the random number table from which the secret session key will be extracted. As one of ordinary skill in the art would recognize, the receiving device 20 may generate the random number table once and store the table in the table memory 340, or may generate the random number table each time a secret session key is to be extracted. Further, the receiving device 20 need not generate the entire random number table. For example, the receiving device may generate only a sufficient number of entries to encompass the start and pointers provided by the sending device 10. As such, the method of generating the random number table in the receiving device in no way limits the scope of the present advancements.

The process of selecting seed values for use in generating random number tables is controlled by the sending device 10. Minimum seed sizes and types of data suitable for use as seed values are chosen to ensure generation of random number tables that are difficult to reproduce without prior knowledge of the seed value 315. For example, seed sizes of 8 bytes or greater are used. The specific number of bytes needed for the seed also depends on the algorithm being used to create the random number tables as one of ordinary skill in the art would recognize.

Random number generator 300, which is a pseudorandom number generator (PRNG), is used for generating a sequence of numbers that approximates the properties of random numbers but are not truly random. In fact, the sequence is determined by a small set of initial values, called the PRNG's state which are referred to herein as the seed value 315. Random seeds or seed values may be generated from the state of the sending device 10, such its clock or time, but as one of ordinary skill in the art would recognize, seed values can be generated from any number of sources that are cryptographically secure such as from a hardware random number generator. Although truly random sequences can be generated using specialized hardware random number generators, pseudorandom numbers stored in random number tables are suitable for use in the present advancements.

Pseudorandom numbers generator algorithms may be linear congruential generators, linear feedback shift registers, feedback with carry shift registers, generalized feedback shift registers, as well as Lagged Fibonacci generators, Blum Blum Shub, Fortuna, and the Mersenne twister. As can be appreciated, the specific algorithm used to generate random numbers is not limiting on the present advancements as long as both the sending device 10 and the receiving device 20 use the same algorithm.

Furthermore, size does matter when determining the size of the random number table. Withstanding cryptographic and computational resources attacks requires selecting keys from random number tables hundreds of times larger than the size of the secret session key used in the symmetric key encryption unit 305. As outlined in Table 1 below, secret session keys used by symmetric key encryption algorithms range from thirty-two (32) bits up to eight thousand one hundred ninety-two (8192) bits. Therefore, a maximum size needed for an all purpose random number table is about five hundred (500) Kilobytes. Even a large key size such as eight thousand one hundred ninety-two (8192) bits or one Kilobyte (1024) bytes can be selected from a table that is over five hundred times (500) larger than the key without repeating a fragment or string of data. As can be appreciated, the present advancements are not limited by the size of the secret session key. For example, secret session key lengths of 144 megabits or larger are possible and limited only by the encryption method used and the size of the random number table used.

TABLE 1
Random Number Table Sizes From which to Select
Secret Session Key Sizes

| | Random Number Table Byte Sizes As | | | | |
|---|---|---|---|---|---|
| Secret Session | Multiples of Key Size | | | | |
| Key Sizes Bits | 100 X | 200 X | 300 X | 400 X | 500 X |
| 32 | 400 | 800 | 1,200 | 1,600 | 2,000 |
| 64 | 800 | 1,600 | 2,400 | 3,200 | 4,000 |
| 128 | 1,600 | 3,200 | 4,800 | 6,400 | 8,000 |
| 256 | 3,200 | 6,400 | 9,600 | 12,800 | 16,000 |
| 512 | 6,400 | 12,800 | 19,200 | 25,600 | 32,000 |
| 1,024 | 12,800 | 25,600 | 38,400 | 51,200 | 64,000 |
| 2,048 | 25,600 | 51,200 | 76,800 | 102,400 | 128,000 |
| 4,096 | 51,200 | 102,400 | 153,600 | 204,800 | 256,000 |
| 8,192 | 102,400 | 204,800 | 307,200 | 409,600 | 512,000 |

Larger random number tables that are only accessible by the intended devices, the sending device 10 and the receiving device 20, allow secret session keys to be selected in a variety of ways, assuring safe and secure encryption. When a random number table is considered as a string of numbers or bits, the secret session key may be extracted by simply selecting a starting and ending point in the string of data. The sending device 10 can select such starting and ending points randomly or using predetermined methods. In addition, the bits in between the start and end points can be manipulated such that every other bit or every third or fifth bit is extracted to form the secret session key. As one of ordinary skill in the art will recognize any number of other schemes can be used to extract the actual secret session key from the random number table without departing from the scope of the present advancements. Further, a method of secret session key extraction can be predetermined and agreed to by the devices beforehand. When the sending device 10 selects the secret session key, a simple code must be included in the secure communications to the receiving device 20 to know what method of secret session key extraction to use on its duplicate random number table to obtain the same secret session key to decrypt the encrypted message being received.

Random number tables can also be fashioned in various shapes and styles from arrays resembling vertical and horizontal stacked mailboxes or bins of random numbers to shapes resembling pyramids, triangles, ovals, circles, stars and rectangles and the like. Even the number of bits stored in each bin or row or column can also have any number of variations. These various methods of secret session key extraction can also be predetermined and agreed to by the devices beforehand. As such, the descriptions of random number table generation provided herein are merely exemplary and do not in any way limit the scope of the present advancements as one of ordinary skill would recognize.

Unique, highly stylized or shaped random number tables that are only accessible by the intended devices, the sending device 10 and the receiving device 20, allow secret session keys to be selected in a variety of ways assuring safe and secure encryption even when a simple exclusive-or operation is used to hide or “mangle” the specific properties of the secret session key, such as the location details of the secret session key within the random number table.

In one exemplary embodiment, a secret session key is selected by the sending device 10 from a portion of n bits of pseudo-random data in the random number table 340 assigned to the appropriate receiving device 20 by a predetermined method that selects a starting point address and an end point address within the n bits of stored pseudo-random data in the random number table 340 stored at the sending device 10, thereby fixing the selected properties for identifying the secret session key's location and length. The sending device 10 stores the selected secret session key in the secret session key buffer 330, and then buffers the selected properties of the secret session key, the starting point address and end point address into a secret session key properties descriptor buffer 365 and transforms the contents of the secret session key properties descriptor buffer into a “mangled” or encoded secret session key properties descriptor buffer 360 by performing an exclusive-or operation on the contents with the user keycode number 345 assigned to the receiving device 20 and stored in the index 355 at the sending device 10.

In another exemplary embodiment, the sending device 10 transforms the contents of the secret session key properties descriptor buffer 365 into a mangled or encoded secret session key properties descriptor buffer 360 by encrypting the contents with the user keycode 345 assigned to the receiving device 20 and stored in the index 355 at the sending device 10 in conjunction with a symmetric secret key encryption unit 305. A secret session key can also be selected by the sending device 10 from a portion of the n bits of pseudo-random data in the random number table 340 assigned to the receiving device 20 by a random method that selects a starting point address and an end point address within the n bits of stored pseudo-random data in the random number table 340 stored at the sending device 20.

Each method of selecting the secret session key from the appropriate random number table requires specific criteria for making the selection. The sending device 10 determines the kind of data or information that is needed by the receiving device 20 to duplicate the method of selecting the secret session key from its copy of the random number table 340. When the method of selection is a random one made by the sending device 10, capturing and placing the starting point address and end point address from within the random number table 340 into a secret session key properties descriptor buffer 365 is sufficient information to apprise the receiving device 20 of the key location within the random number table. However, if additional operations are performed by the sending device 10 during the selection process, such as the skip bits scheme described above, additional information is needed to describe those optional processes taken along with the starting point address and end point address. These additional operations may be predetermined, agreed to beforehand and taken without extra notice as a process in common between the devices when creating and duplicating the cryptic references or specific properties to where the entire secret session key can be found within the secured shared random number table containing the vast array of random values. As one of ordinary skill would recognize, any predetermined method of selecting the secret session key from the appropriate random number table 340 may also be taken without extra notice as a process in common between the devices without departing from the scope of the claimed advancements. For example, additional obstacles to hacking may be created by constantly changing the specific properties used to identify the secret session key within the random number table 340.

After the sending device 10 encodes the contents of the secret session key properties descriptor buffer 360 as described above, it obtains the data or content to be transmitted to the receiving device 20 and places the content into an input/output buffer 310. The sending device 10 initiates a symmetric secret key encryption method in conjunction with the selected secret session key stored in the secret session key buffer 330 and encrypts the contents of the input/output buffer 310 into an encrypted content. As can be appreciated, any symmetric secret key encryption method can be used without departing from the scope of the claimed advancements.

While preparing for transmitting to the receiving device 20, the sending device copies from the stored index 355 the unique device number 345 assigned to the receiving device 20 and the contents of the encoded secret session key properties descriptor buffer 365 into a temporary buffer or header 320, which becomes supplemental data placed at the beginning of a block of data being transmitted. Creating a connection with the receiving device 20, the sending device 10 transmits to the receiving device 20 the contents of the header 320 and encrypted content of the input/output buffer 310 or payload.

The receiving device 20 verifies upon receipt of both the header 320 and the payload 310 that the receiving device 20 is authorized to receive and decode the transmission by comparing the portion of the header 320 which contains the assigned unique device number with its own known previously assigned unique device number 345 to determine if they match. If they don't match, then the transmission ends. If there is a match, the receiving device 20 extracts from the header 320 the data containing the encoded secret session key properties descriptor into a temporary copied mangled secret session key properties descriptor buffer 360 where it decodes and restores the contents of the secret session key properties descriptor buffer 365. This is achieved by using the same method that the sending device 10 used to encode the secret session key properties descriptor before it transmitted it to the receiving device 20. The receiving device 20 now restores the secret session key specific properties descriptor to match the contents of the sending device's originally created secret session key properties descriptor buffer before the sending device encrypted it.

Utilizing the selected properties of the secret session key in the restored secret session key specific properties descriptor buffer 365, the starting point address and end point address as location markers, the receiving device 20 extracts the secret session key from the previously created, mutually shared and stored n bits of pseudo-random data in the random number table 340, that it originally received from the sending device 10, as described above, thereby creating a duplicate secret session key matching the one created and used by the original sending device 10 which it now stores in the Secret Session Key Buffer 330 in the Secure Memory 370.

The random number table 340 may also be installed in conjunction with a mutually identical pseudo-random number generator 300 and a mutually shared seed value 315 between the devices as previously as discussed above. The random number table may further be preloaded from prior communications between the devices. In still another exemplary embodiment, the random number table is installed prior to any communication between the devices from a network server or at a manufacturing facility where the devices were fabricated.

Regardless of how the devices obtained their identical random number tables 340 as the source from which to extract the appropriate secret session key, the receiving device 20 decrypts the payload by initiating the same symmetric key encryption method used by the sending device 10 in conjunction with the duplicate secret session key stored in the Secret Session Key Buffer 330 in the Secure Memory 370 and transforms the payload into the contents of the input/output buffer 310 in its original unencrypted state.

The receiving device 20 has now obtained the restored contents data of the input/output buffer 310 which is as was the intended original purpose of the communication process. The receiving device 20 is able to perform such other operations or communications as instructed by and/or understood from using, reading or playing the contents of the input/output buffer 310. If the devices desire to terminate the communication between them then the process ends. However, when a determination is made by the receiving device 20 that additional communications with the sending device 10 is required from using, reading or playing the contents of the input/output buffer 310, the receiving device 20 must prepare to perform the necessary steps required by the invention to virtually switch roles, duties and tasks and now become the sending device in a reply communication process which develops into a two-way communication between the devices as described next.

After determining that additional communications with the sending device 10 is required from using, reading or playing the contents of the input/output buffer 310, the receiving device 20 transforms the contents of the restored secret session key properties descriptor buffer 365 into an encoded secret session key properties descriptor buffer 360 by performing an exclusive-or operation on the contents with the user keycode number assigned to the original sending device 10 and stored in a secure manner at the receiving device 20 in secure memory 370. If sending device's user keycode was not shared with the receiving device 20 in a prior secured communication, then the receiving device 20 encodes the contents of the restored secret session key properties descriptor buffer 365 into an encoded secret session key properties descriptor buffer 360 by performing an exclusive-or operation on the contents with the receiving device's own user keycode number 345 stored in a secure memory 370 of the receiving device 20.

As requested or instructed from using, reading or playing the contents of the input/output buffer 310, the receiving device 20 obtains or creates the necessary data or content to be transmitted to the sending device 10 and stores this new content into the input/output buffer 310. Initiating a symmetric secret key encryption method 305 in conjunction with the recently restored and stored secret session key in the Secret Session Key Buffer 330, the receiving device 20 encrypts the contents of the input/output buffer 310 thereby transforming the contents of the input/output buffer 310 into encrypted content.

While preparing for transmitting to the sending device 10, the receiving device 20 copies the unique device number assigned to the sending device 10 and stored in a secured manner at the receiving device 20 and the contents of the encoded secret session key properties descriptor buffer 360 into a temporary buffer or header 320 which is supplemental data placed at the beginning of a block of data being transmitted and re-establishing, if necessary, a connection with the sending device 10, the receiving device 20 transmits to the sending device 10 the contents of the header 320 and encrypted content of the input/output buffer or payload 310.

The sending device 10 then verifies, upon receipt of both the header 320 and the payload 310, that it is authorized to receive and decode the transmission by comparing that portion of the header which contains the assigned unique device number with its own known previously assigned unique device number to determine if they match. If there is no match, then the transmission abruptly ends. However, if there is a match, the sending device 10 extracts from the header 320 the data containing the encoded secret session key properties descriptor into a temporary copied mangled secret session key properties descriptor buffer 360 and decodes the contents of the copied mangled secret session key properties descriptor buffer 360 by performing an exclusive-or operation on the contents with its own assigned, secret unique user keycode, provided it was sent previously to the receiving device. If not then the sending device 10 decodes the contents of the copied mangled secret session key properties descriptor buffer 360 using the receiving device's assigned, secret unique user keycode 345 to restore the secret session key specific properties descriptor 365.

By utilizing the selected properties of the secret session key revealed now in the restored secret session key specific properties descriptor buffer 365, the starting point address and end point address as location markers, the sending device 10 extracts the secret session key from the previously created, mutually shared and stored n bits of pseudo-random data in the random number table 340 it originally created, thereby creating a duplicate secret session key matching the one created and used by the transmitting receiving device 20 which it now stores in the Secret Session Key Buffer 330 in the Secure Memory 370. After initiating the same symmetric key encryption method 305 used by the receiving device 20 in conjunction with the duplicate secret session key in Secret Session Key Buffer 330, the sending device 10 decrypts the payload by and transforming the payload into the contents of the input/output buffer 310 as its original state before the receiving device encrypted and securely transmitted it to the sending device.

The sending device 10 has now obtained the contents of the input/output buffer 310, and is now able to perform other operations or communications as instructed by and/or understood from using, reading or playing the contents of the input/output buffer 310. If the devices desire to terminate the communication between them then the process ends. However, when a determination is made by the sending device 10 that additional communications with the receiving device 20 is required, the sending device 10 must prepare to perform the necessary steps required by the invention to again participate in a reply communication process which develops into another two-way communication between the devices with the process beginning over again.

In other embodiments of two-way communications, the receiving device 20 transforms by encrypting, in a predetermined manner with a symmetric key encryption method in conjunction with the receiving device's own user keycode, the contents of the restored secret session key properties descriptor buffer 365 into an encoded secret session key properties descriptor buffer 360.

As one of ordinary skill in the art would recognize, the nature of the content being securely transmitted between the devices can be anything and take on many forms. For example, the content can be a few words spoken as commands for a military offensive or critical information for police, fire and rescue and their corresponding replies, complete video feeds from the camera on a missile or a satellite, or even one mounted on an unmanned aerial vehicle (UAV). As such, examples of content data such as streaming data, audio, video and text do not in any way limit the scope of the present advancements.

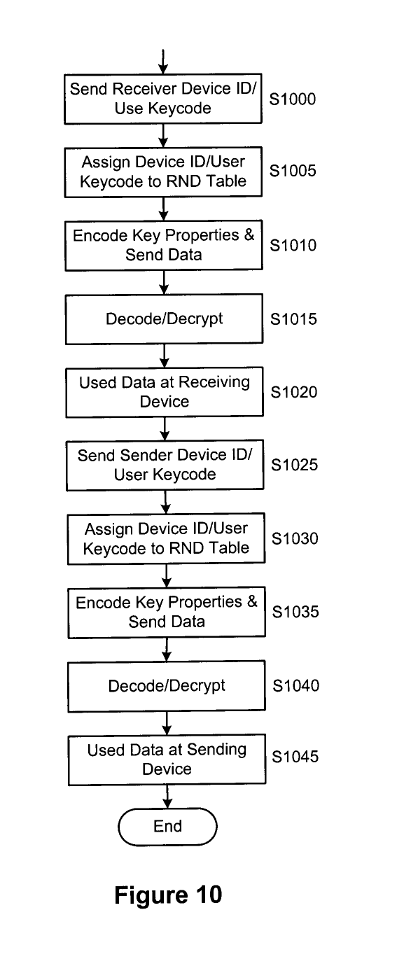

FIG. 10 is a flowchart of two-way communication between the sending device 10 and the receiving device 20. In FIG. 10, the receiving device 20 sends the unique device number 335 and user keycode number 345 at step S1000, as described above. Then, the sending device 10 assigns the unique device number 335 and user keycode number 345 to a random number table 340 at step S1005. As discussed above, the sending device 10 identifies a secret session key in the random number table 340, determines the key properties corresponding thereto, and encodes the key properties as a header 320 to the data to be transmitted 310 at step S1010.

The receiving device 20 decodes the key properties at step S1015, provided that the receiving device 20 is authorized to decrypt the transmitted data. At step S1020, the receiving device 20 decrypts and uses the transmitted data 310. Thus, up to this point, the two-way communication method is the same as the one-way communication method described above.

If further communication is necessary, the sending device 10 sends its own unique device number and user keycode number to the receiving device 20 at step S1025. The receiving device 20 then assigns a random number table 340 to the unique device number and user keycode number of the sending device 10 at step S1030. Then, the receiving device 20 identifies a secret session key, and encodes properties corresponding thereto, which are then transmitted as a header to data transmitted from the receiving device 20 to the sending device 10 at step S1035.

At step S1040, the sending device 10 decodes the key properties to identify a secret session key within a random number table 340 contained therein in order to decrypt and use the data transmitted from the receiving device 20. At step S1045, the sending device 10 decrypts the data and if further communication is warranted, the process repeats from step S1000. In this way, two-way communication may be viewed as alternating one-way communications wherein in one leg the sending device 10 controls the communication and in the return leg, the receiving device 20 controls the communication.

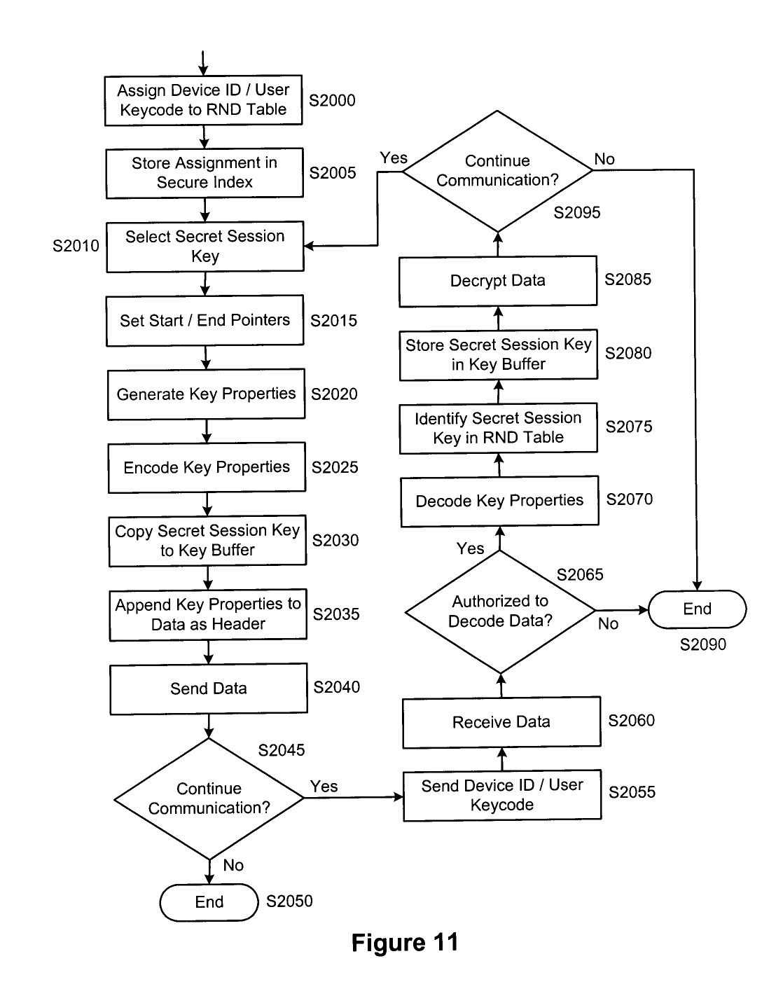

Next, a description of the two-way communication process with respect to the sending device 10 is provided. In FIG. 11, communication begins at step S2000 by assigning the unique device number and user keycode number of the receiving device 20 to a random number table. At step S2005, the sending device 10 stores the assignment in an index 355 in a secure memory 370. Then, the sending device 10 selects a secret session key from the random number table 340 at step S2010. Selection of the secret session key may be performed at random, by a predetermined algorithm, or any other method that is known in the art. As such, one of ordinary skill would recognize that the method of selecting the secret session key in no way limits the scope of the present advancements.

Once the secret session is selected, the sending device 10 sets a start and end pointer at step S2015 to identify the secret session key within the random number table 340. At step S2020, the sending device 10 determines key properties, such as length, start address, end address, etc., based on the start and end pointers. The key properties are then encoded using either encryption or a simple exclusive-or function at step S2025. At step S2030, the sending device 10 copies the secret session key to the key buffer 330. At step S2030, the sending device 10 also encodes and appends the key properties to the data to be transmitted to the receiving device 20. The process of encoding and appending the key properties to the data has been described above and therefore will be omitted here for brevity.

At step S2040, the sending device 10 transmits the data to the receiving device 20. At step S2045, the sending device 10 determines whether further transmission is necessary. For example, the sending device 10 may determine that further transmission is necessary if the data being transmitted to the receiving device 20 is being transmitted in parts. Thus, several transmissions may be necessary to completely send the entire set of data. Alternatively, the sending device 10 may determine that further transmission is necessary when it receives a reply from the receiving device 20. Other methods are also possible as one of ordinary skill in the art would recognize.

If, at step S2045, the sending device 10 determines that further transmission is not necessary, communication between the sending device 10 and the receiving device 20 terminates at step S2050. Otherwise, if further transmission is necessary, the sending device 10 transmits its own device ID and user key code to the receiving device 20 at step S2055. Then the sending device 10 awaits further transmission from the receiving device 30.

At step S2060, the sending device receives a transmission from the receiving device 20. At step S2065, the sending device 10 determines whether it is authorized to decrypt the transmission by comparing its user keycode 345 to the user keycode 345 transmitted in the data transmission. If the two user keycodes do not match, transmission ends at step S2090. Otherwise, the sending device 10 proceeds to step S2070 where it decodes the key properties. The decoded key properties are then used to identify the secret session key in the random number table 340 to which unique device number and user keycode number of the sending device 10 have been assigned at step S2075. The secret session key is then stored in the key buffer 330 at step S2080, and the data is decrypted at step S2085. This process repeats until one or both devices determine that communication should end.

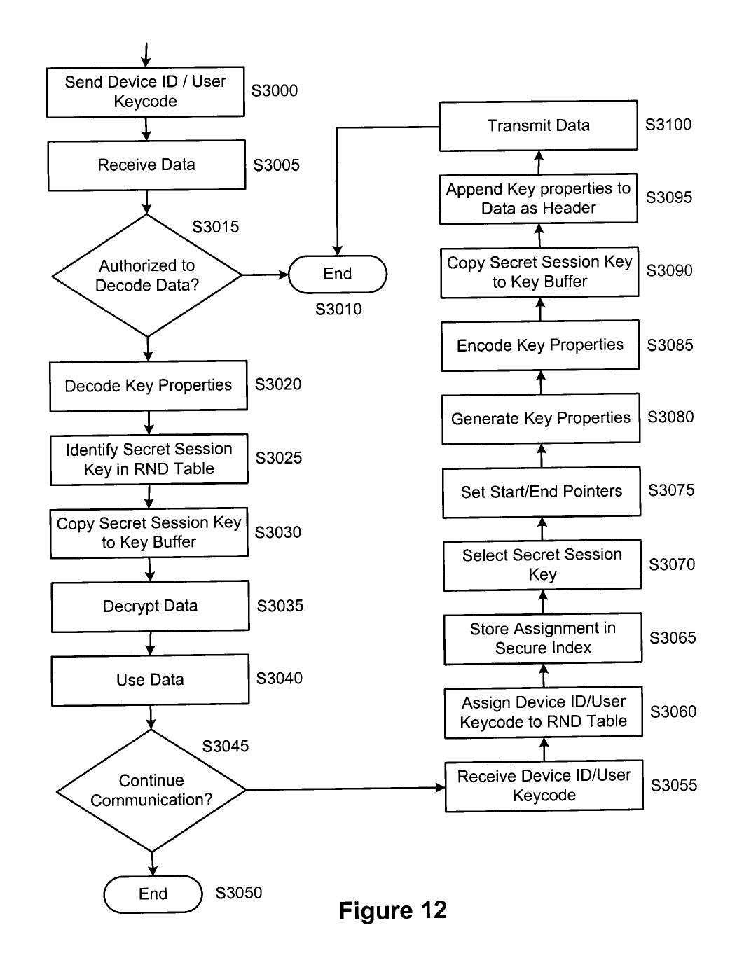

In FIG. 12, the two-way communication process in the receiving device 20 is described. At step S3000, the receiving device 20 transmits its unique device number and user keycode number to the sending device 10, and then awaits a transmission from the sending device 10. At step S3005, the receiving device 20 receives a transmission from the sending device 10. At step S3015, the receiving device 20 determines whether it is authorized to decrypt the received transmission, by determining whether there is a match between the user keycode 345 stored in the receiving device 20 and the user keycode 345 included in the transmission. If a match does not exist, the transmission ends at step S3010. Otherwise, the key properties that identify the secret session key within the random number table 340 assigned to the unique device number and user keycode number 345 of the receiving device 20 is decoded at step S3020. Decoding of the key properties may include decrypting the key properties or merely performing an exclusive-or operation.

Next, at step S3025, the receiving device 20 identifies the secret session key within the random number table 340 using the decoded key properties. At step S3030, the secret session key is copied to the secret session key buffer 330. Then, the receiving device 20 uses the secret session key stored in the key buffer 330 to decrypt the transmitted data. The transmitted data is then analyzed and/or otherwise used at step S3040.

At step S3045, the receiving device 20 determines whether further transmission is necessary. For example, the receiving device may determine that the transmitted data is incomplete and that further transmission from the sending device 10 is necessary. Alternatively, the receiving device 20 may receive a separate message from the sending device 10 that transmission has not concluded or that the sending device 10 is expecting a reply. If no further transmission is necessary, the process ends at step S3050.

If, however, further transmission is necessary, the receiving device 20 receives the unique device number 335 and user keycode number 345 of the sending device 10 at step S3055. At step S3060, the unique device number 335 and user keycode number 345 of the sending device 10 is assigned to a random number table 340. This second random number table 340 may be the same as the random number table assigned to unique device number 335 and user keycode number 345 of the receiving device 20, or may be a different random number table.

Once the unique device number 335 and user keycode number 345 of the sending device 10 have been assigned, the receiving device 20 stores the assignment in an index 355 at step S3065. At step S3070, the receiving device 20 selects a secret session key for its transmission to the sending device 10. As can be appreciated, selection of the secret session key may be done randomly, by a preset algorithm, or by any other method of selecting data from a table that is known. As such, any method described herein for selecting a specific secret session key is merely exemplary and in no way limits the scope of the present advancements.

Once the receiving device 20 has selected the secret session key and stores it in the Secret Session Key Buffer 330 in the Secure memory 370, the receiving device 20 assigns a start and an end pointer to the secret session key in order to identify its location within the random number table 340 at step S3075. Then, the receiving device 20 determines key properties for further identifying the location and size of the secret session key within the random number table at step S3080. At step S3085, the receiving device 20 encodes the key properties using either an exclusive OR function or encryption. The receiving device 20 also copies the secret session key to the key buffer 330 at step S3090. The encoded key properties are appended to the data to be transmitted to the sending device 10 at step S3095, and the data is sent at step S3100. This process is continued until one or both devices determine that communication is no longer necessary.

As one of ordinary skill in the art would recognize, any processes, descriptions or blocks in flow charts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order, depending upon the functionality involved.

Obviously, numerous modifications and variations of the present invention are possible in light of the above teachings. It is therefore to be understood that within the scope of the appended claims, the invention may be practiced otherwise than that specifically described herein.

1. A method of creating and exchanging secret session keys for symmetric secret key encryption between a sending device and a receiving device without transmitting the actual secret session keys between the sending and receiving devices, the method comprising:
providing the receiving device with a unique device number, a unique user keycode number, and a symmetric secret key encryption algorithm;
providing the sending device with the symmetric secret key encryption algorithm, a seed value and a non-system randomizer to generate a predetermined number of pseudo-random bit data based on the seed value, the pseudo-random bit data being arranged into a random number table stored in an electronic memory of the sending device;
transmitting from the receiving device to the sending device through secured communication both the unique device number and the unique user keycode number;
assigning, at the sending device, the random number table to the unique device number and unique user keycode number, the assignment being stored in a secret index in the electronic memory of the sending device;
selecting, at the sending device, a secret session key as a subset of the pseudo-random bit data in the random number table;
assigning, at the sending device, a start pointer corresponding to a start point of the subset of pseudo-random bit data and an end pointer corresponding to an end point of the subset of pseudo-random bit data;
determining selected properties identifying length and location of the subset of pseudo-random bit data in the random number table, the subset of pseudo-random bit data being the secret session key;
storing the selected properties and the start and end pointers of the secret session key in a secret session key properties descriptor buffer of the sending device;
copying into a secret session key buffer at the sending device the secret session key corresponding to the selected properties of the secret session key from within the predetermined number of pseudo-random bit data in the random number table stored at the sending device index, by utilizing the start and end pointers to locate the secret session key;
transforming the contents of the secret session key properties descriptor buffer into mangled secret session key properties;
storing the data to be transmitted to the receiving device in an input/output buffer of the sending device;
encrypting, at the sending device, the data in the input/output buffer using the symmetric key encryption algorithm and the secret session key stored in the secret session key buffer to generate an encrypted content;
appending, at the sending device, the unique device number and the mangled secret session key properties as a header of the encrypted content;
creating a connection between the sending device and the receiving device;
transmitting the encrypted content with the appended header from the sending device to the receiving device;
verifying, at the receiving device, the unique device number in the header of the encrypted content with the unique device number stored in the receiving device to determine whether the receiving device is authorized to decrypt the encrypted content;
extracting, at the receiving device, the mangled secret session key properties when the receiving device is authorized to decrypt the encrypted content, the mangled session key properties being stored in a copied mangled secret session key properties descriptor buffer of the receiving device;
restoring the contents of the copied mangled secret session key properties descriptor buffer, the restored secret session key properties corresponding to the secret session key properties at the sending device, the restored session key properties including the selected properties, the start pointer and the end pointer of the secret session key;
utilizing, at the receiving device, at least a subset of the selected properties, the starting pointer and the end pointer to extract the secret session key from a predetermined number of pseudo-random bit data previously stored in the receiving device, the predetermined number of pseudo-random bit data stored in the receiving device corresponding to the predetermined number of pseudo-random bit data stored in the sending device, the extracted secret session key being a duplicate of the secret session key stored in the sending device;
decrypting the encrypted content at the receiving device using the symmetric key encryption algorithm and the extracted secret session key when the receiving device is authorized to decrypt the encrypted content, the decrypted content being stored in an input/output buffer of the receiving device; and
securely using, reading or playing the contents of the input/output buffer of the receiving device, the secret session key having been successfully created and exchanged between the sending and receiving devices without exchanging or transmitting the actual secret session keys therebetween, the secure communication between the sending and receiving devices of encrypted content being maintained until termination of the communication is initiated by at least one of the sending and receiving devices.

2. The method according to claim 1, further comprising:
prior to transmitting the encrypted content, transmitting from the sending device to the receiving device through secured communication the predetermined number of pseudo-random bit data in the random number table to the receiving device having the unique device number and unique user keycode number corresponding to the random number table; and
securely storing in an electronic memory of the receiving device, the predetermined number of pseudo-random bit data received from the sending device, the predetermined number of pseudo-random bit data being stored in association with the device number and the user keycode.

3. The method according to claim 1, further comprising:
providing the receiving device with non-system randomizer software identical to the non-system randomizer software used by the sending device to generate the predetermined number of pseudo-random bit data included in the random number table;
prior to transmission of the encrypted content, transmitting from the sending device to the receiving device, the seed value via secure communication, the seed value corresponding to the pseudo-random bit data in the random number table associated with the unique device number and unique user keycode number of the receiving device;
generating a predetermined number of pseudo-random bit data at the receiving device using the non-system randomizer software and seed value; and
securely storing in an electronic memory of the receiving device, the predetermined number of pseudo-random bit data generated based on the seed value as a random number table associated with the unique device number and the unique user keycode number.

4. The method according to claim 1, further comprising:
providing the receiving device with a plurality of unique secret user keycode numbers assigned thereto;
securely transmitting, from the receiving device to the sending device, the unique device number and one of the plurality of unique user keycode numbers not assigned to a random number table stored at the receiving device;
associating, in the secret index of the sending device, the random number table to the unique device number and the one of the plurality of unique user keycode numbers received from the receiving device;
prior to transmitting the encrypted content, transmitting from the sending device to the receiving device through secured communication the predetermined number of pseudo-random bit data in the random number table to the receiving device having the unique device number and the one of the plurality of unique user keycode numbers corresponding to the random number table; and
securely storing in an electronic memory of the receiving device, the predetermined number of pseudo-random bit data received from the sending device, the predetermined number of pseudo-random bit data being stored in association with the device number and the one of the plurality of unique user keycode numbers.

5. The method according to claim 1, wherein the secret session key is selected as a subset of the predetermined number of pseudo-random bit data of the random number data by identifying the start pointer and the end pointer corresponding to the secret session key using a predetermined algorithm.

6. The method according to claim 1, wherein the secret session key is randomly selected as a subset of the predetermined number of pseudo-random bit data of the random number data by identifying the start pointer and the end pointer corresponding to the secret session key using a random method.

7. The method according to claim 1, wherein transforming the contents of the secret session key properties descriptor buffer in the sending device includes performing an exclusive-or operation between the contents of the secret session key properties descriptor buffer and the unique user keycode number corresponding to the receiving device, and
restoring the contents of the copied mangled secret session key properties descriptor buffer includes performing an exclusive-or operation between the contents of the copied mangled secret session key properties descriptor buffer and the unique user keycode number.

8. The method according to claim 1, wherein transforming the contents of the secret session key properties descriptor buffer includes encrypting the contents of the secret session key properties descriptor buffer using symmetric secret key encryption and the unique user keycode number, and
restoring the contents of the copied mangled secret session key properties descriptor buffer includes decrypting with the symmetric secret key encryption and the unique user keycode number.

9. The method of claim 1, wherein the data to be transmitted by the sending device is streaming data, and each block of the streaming data is stored in the input/output buffer upon transmission of the previously stored block of the streaming data to the receiving device.

10. The method according to claim 9, wherein transforming the contents of the secret session key properties descriptor buffer includes encrypting the contents of the secret session key properties descriptor buffer using symmetric secret key encryption and the unique user keycode number, and
restoring the contents of the copied mangled secret session key properties descriptor buffer includes decrypting with the symmetric secret key encryption and the unique user keycode number.

11. A method of creating and exchanging secret session keys used in symmetric secret key encryption between a sending device and a receiving device engaged in two way communication, the secret session key being exchanged without transmitting the actual secret session key between the sending and receiving devices, the method comprising:
providing the receiving device with a unique device number, a unique user keycode number assigned thereto, and a symmetric secret key encryption algorithm;
providing the sending device with a unique device number, a unique user keycode assigned thereto, a seed value, the symmetric secret key encryption algorithm, and a non-system randomizer software;
transmitting, from the receiving device to the sending device, the unique device number and unique user keycode corresponding to the receiving device;
transmitting, from the sending device to the receiving device, the unique device number and unique user keycode corresponding to the sending device;
generating, at the sending device, a predetermined number of pseudo-random bit data using the seed value, the predetermined number of pseudo-random bit data forming a random number table;
assigning, in a secret index stored in an electronic memory of the sending device, the random number table to unique device number and the unique user keycode number corresponding to the receiving device;
securely storing in the electronic memory of the receiving device, the unique device number and the unique user keycode number corresponding to the sending device;
selecting, at the sending device, a secret session key as a subset of the pseudo-random bit data in the random number table corresponding to the unique device number and unique user keycode number of the receiving device;
selecting, at the sending device, a start pointer and an end pointer corresponding to the subset of the pseudo-random bit data, the start and end pointers defining selected properties of the secret session key including a length and random number table location thereof;
storing the selected properties of the secret session key, the start pointer and the end pointer into a secret session key properties descriptor buffer of the sending device;
copying the secret session key into a secret session key buffer of the sending device using the start and end pointers to locate the secret session key within the random number table, the secret session key corresponding to the selected properties of the secret session key;
encoding, at the sending device, the contents of the secret session key properties descriptor buffer into mangled secret session key properties;
storing in an input/output buffer of the sending device, data to be encrypted and transmitted to the receiving device;
encrypting, at the sending device, the data in the input/output buffer using the symmetric key encryption algorithm and the secret session key stored in the secret session key buffer to generate an encrypted content;
appending, at the sending device, the unique device number and mangled secret session key properties as a header of the encrypted content;
creating a connection between the sending device and the receiving device;
transmitting the encrypted content with the appended header from the sending device to the receiving device;
verifying, at the receiving device, the unique device number in the header of the encrypted content with the unique device number stored in the receiving device to determine whether the receiving device is authorized to decrypt the encrypted content;
extracting, at the receiving device, the mangled secret session key properties when receiving device is authorized to decrypt the encrypted content, the mangled session key properties being stored in a copied mangled secret session key properties descriptor buffer of the receiving device;
restoring the contents of the copied mangled secret session key properties descriptor buffer, the restored secret session key properties corresponding to the secret session key properties at the sending device, the restored session key properties including the selected properties, the start pointer and the end pointer of the secret session key;
utilizing, at the receiving device, at least a subset of the selected properties, the starting pointer and the end pointer to extract the secret session key from a predetermined number of pseudo-random bit data previously stored in the receiving device, the predetermined number of pseudo-random bit data stored in the receiving device corresponding to the predetermined number of pseudo-random bit data stored in the sending device, the extracted secret session key being a duplicate of the secret session key stored in the sending device;
decrypting the encrypted content at the receiving device using the symmetric key encryption algorithm and the extracted secret session key when receiving device is authorized to decrypt the encrypted content, the decrypted content being stored in an input/output buffer of the receiving device;
securely using, reading or playing the contents of the input/output buffer of the receiving device, the secret session key having been successfully created and exchanged between the sending and receiving devices without exchanging or transmitting the actual secret session keys therebetween;
determining, at the receiving device, whether additional communication with the sending device is required based on the contents of the input/output buffer;
encoding, at the receiving device, restored secret session key properties into mangled secret session key properties, and storing the mangled secret session key properties into a mangled secret session key properties descriptor buffer;
storing data to be encrypted and transmitted from the receiving device to the sending device in an input/output buffer of the receiving device;
encrypting, at the receiving device, the data in the input/output buffer using the symmetric key encryption algorithm and the secret session key to generate an encrypted content;
appending, at the receiving device, the unique device number of the sending device and the contents of the mangled secret session key properties descriptor buffer as a header of the encrypted content;
creating a connection between the receiving device and the sending device;
transmitting the encrypted content with the appended header from the receiving device to the sending device;
verifying, at the sending device, the unique device number in the header of the encrypted content with the unique device number stored in the sending device to determine whether the sending device is authorized to decrypt the encrypted content;
extracting, at the sending device, the mangled secret session key properties when the sending device is authorized to decrypt the encrypted content, the mangled session key properties being stored in a copied mangled secret session key properties descriptor buffer of the sending device;
restoring the contents of the copied mangled secret session key properties descriptor buffer, the restored secret session key properties corresponding to the secret session key properties at the receiving device, the restored secret session key properties including the selected properties, the start pointer and the end pointer of the secret session key;
utilizing, at the sending device, at least a subset of the selected properties, the starting pointer and the end pointer to extract the secret session key from a predetermined number of pseudo-random bit data previously stored in the sending device, the predetermined number of pseudo-random bit data stored in the sending device corresponding to the predetermined number of pseudo-random bit data stored in the receiving device, the extracted secret session key being a duplicate of the session key stored in the receiving device;
decrypting the encrypted content at the sending device using the symmetric key encryption algorithm and the extracted secret session key when the sending device is authorized to decrypt the encrypted content, the decrypted content being stored in an input/output buffer of the sending device;
securely using, reading or playing the contents of the input/output buffer of the receiving device, the secret session key having been successfully created and exchanged between the sending and receiving devices without exchanging or transmitting the actual secret session keys therebetween;
repeating all steps above until at least one of the sending device and the receiving device ends communication therebetween.

12. The method according to claim 11, further comprising:
prior to transmitting the encrypted content from the sending device to the receiving device, transmitting from the sending device to the receiving device through secured communication the predetermined number of pseudo-random bit data in the random number table to the receiving device having the unique device number and unique user keycode number corresponding to the random number table; and
securely storing in an electronic memory of the receiving device, the predetermined number of pseudo-random bit data received from the sending device, the predetermined number of pseudo-random bit data being stored in association with the device number and the user keycode.

13. The method according to claim 11, further comprising:
providing the receiving device with non-system randomizer software identical to the non-system randomizer software used by the sending device to generate the predetermined number of pseudo-random bit data included in the random number table;
prior to transmission of the encrypted content, transmitting from the sending device to the receiving device, the seed value via secure communication, the seed value corresponding to the pseudo-random bit data in the random number table associated with the unique device number and unique user keycode number of the receiving device;
generating a predetermined number of pseudo-random bit data at the receiving device using the non-system randomizer software and seed value; and
securely storing in an electronic memory of the receiving device, the predetermined number of pseudo-random bit data generated based on the seed value as a random number table associated with the unique device number and the unique user keycode number,
wherein the seed value is used to transmit encrypted contents from the sending device to the receiving device and to transmit encrypted contents from the receiving device to the sending device.

14. The method according to claim 11, further comprising:
providing the receiving device with a plurality of unique secret user keycode numbers assigned thereto;
securely transmitting, from the receiving device to the sending device, the unique device number and one of the plurality of unique user keycode numbers not assigned to a random number table stored at the receiving device;
associating, in the secret index of the sending device, the random number table to the unique device number and the one of the plurality of unique user keycode numbers received from the receiving device;
prior to transmitting the encrypted content, transmitting from the sending device to the receiving device through secured communication the predetermined number of pseudo-random bit data in the random number table to the receiving device having the unique device number and the one of the plurality of unique user keycode numbers corresponding to the random number table; and
securely storing in an electronic memory of the receiving device, the predetermined number of pseudo-random bit data received from the sending device, the predetermined number of pseudo-random bit data being stored in association with the device number and the one of the plurality of unique user keycode numbers.

15. The method according to claim 11, wherein the secret session key is selected as a subset of the predetermined number of pseudo-random bit data of the random number data by identifying the start pointer and the end pointer corresponding to the secret session key using a predetermined algorithm.

16. The method according to claim 11, wherein the secret session key is randomly selected as a subset of the predetermined number of pseudo-random bit data of the random number data by identifying the start pointer and the end pointer corresponding to the secret session key using a random method.

17. The method according to claim 11, wherein transforming the contents of the secret session key properties descriptor buffer in the sending device includes performing an exclusive-or operation between the contents of the secret session key properties descriptor buffer and the unique user keycode number corresponding to the receiving device,
restoring the contents of the copied mangled secret session key properties descriptor buffer of the receiving device includes performing an exclusive-or operation between the contents of the copied mangled secret session key properties descriptor buffer and the unique user keycode number of the receiving device,
transforming the contents of the secret session key properties descriptor buffer in the receiving device includes performing an exclusive-or operation between the contents of the secret session key properties descriptor buffer and the unique user keycode number corresponding to the sending device, and
restoring the contents of the copied mangled secret session key properties descriptor buffer of the sending device includes performing an exclusive-or operation between the contents of the copied mangled secret session key properties descriptor buffer and the unique user keycode number of the sending device.

18. The method according to claim 11, wherein transforming the contents of the secret session key properties descriptor buffer in the sending device includes encrypting the contents of the secret session key properties descriptor buffer using symmetric secret key encryption and the unique user keycode number of the receiving device,
restoring the contents of the copied mangled secret session key properties descriptor buffer of the receiving device includes decrypting with the symmetric secret key encryption and the unique user keycode number of the receiving device,
transforming the contents of the secret session key properties descriptor buffer in the receiving device includes encrypting the contents of the secret session key properties descriptor buffer using symmetric secret key encryption and the unique user keycode number of the sending device, and
restoring the contents of the copied mangled secret session key properties descriptor buffer of the sending device includes decrypting with the symmetric secret key encryption and the unique user keycode number of the sending device.

19. The method according to claim 11, wherein the data to be transmitted by the sending device is streaming data and each block of the streaming data is stored in the input/output buffer upon transmission of the previously stored block of the streaming data to the receiving device, and
the data to be transmitted by the receiving device is streaming data and each block of the streaming data is stored in the input/output buffer upon transmission of the previously stored block of the streaming data to the sending device.

20. The method according to claim 19, wherein transforming the contents of the secret session key properties descriptor buffer in the sending device includes encrypting the contents of the secret session key properties descriptor buffer using symmetric secret key encryption and the unique user keycode number of the receiving device,
restoring the contents of the copied mangled secret session key properties descriptor buffer of the receiving device includes decrypting with the symmetric secret key encryption and the unique user keycode number of the receiving device,
transforming the contents of the secret session key properties descriptor buffer in the receiving device includes encrypting the contents of the secret session key properties descriptor buffer using symmetric secret key encryption and the unique user keycode number of the sending device, and
restoring the contents of the copied mangled secret session key properties descriptor buffer of the sending device includes decrypting with the symmetric secret key encryption and the unique user keycode number of the sending device.

21. A computer-readable medium storing computer-readable instructions thereon, the computer-readable instructions, when executed by a processor cause the processor to perform a method comprising:
providing a receiving device with a unique device number, a unique user keycode number, and a symmetric secret key encryption algorithm;
providing a sending device with a symmetric secret key encryption algorithm, a seed value and a non-system randomizer to generate a predetermined number of pseudo-random bit data based on the seed value, the pseudo-random bit data being arranged into a random number table stored in an electronic memory of the sending device;
transmitting from the receiving device to the sending device through secured communication both the unique device number and the unique user keycode number;
assigning, at the sending device, the random number table to the unique device number and unique user keycode number, the assignment being stored in a secret index in the electronic memory of the sending device;
selecting, at the sending device, a secret session key as a subset of the pseudo-random bit data in the random number table;
assigning, at the sending device, a start pointer corresponding to a start point of the subset of pseudo-random bit data and an end pointer corresponding to an end point of the subset of pseudo-random bit data;
determining selected properties identifying length and location of the subset of pseudo-random bit data in the random number table, the subset of pseudo-random bit data being the secret session key;
storing the selected properties and the start and end pointers of the secret session key in a secret session key properties descriptor buffer of the sending device;
copying into a secret session key buffer at the sending device the secret session key corresponding to the selected properties of the secret session key from within the predetermined number of pseudo-random bit data in the random number table stored at the sending device index, by utilizing the start and end pointers to locate the secret session key;
transforming the contents of the secret session key properties descriptor buffer into mangled secret session key properties;
storing the data to be transmitted to the receiving device in an input/output buffer of the sending device;
encrypting, at the sending device, the data in the input/output buffer using the symmetric key encryption algorithm and the secret session key stored in the secret session key buffer to generate an encrypted content;
appending, at the sending device, the unique device number and the mangled secret session key properties as a header of the encrypted content;
creating a connection between the sending device and the receiving device;
transmitting the encrypted content with the appended header from the sending device to the receiving device;
verifying, at the receiving device, the unique device number in the header of the encrypted content with the unique device number stored in the receiving device to determine whether the receiving device is authorized to decrypt the encrypted content;
extracting, at the receiving device, the mangled secret session key properties when the receiving device is authorized to decrypt the encrypted content, the mangled session key properties being stored in a copied mangled secret session key properties descriptor buffer of the receiving device;
restoring the contents of the copied mangled secret session key properties descriptor buffer, the restored secret session key properties corresponding to the secret session key properties at the sending device, the restored session key properties including the selected properties, the start pointer and the end pointer of the secret session key;
utilizing, at the receiving device, at least a subset of the selected properties, the starting pointer and the end pointer to extract the secret session key from a predetermined number of pseudo-random bit data previously stored in the receiving device, the predetermined number of pseudo-random bit data stored in the receiving device corresponding to the predetermined number of pseudo-random bit data stored in the sending device, the extracted secret session key being a duplicate of the secret session key stored in the sending device;
decrypting the encrypted content at the receiving device using the symmetric key encryption algorithm and the extracted secret session key when the receiving device is authorized to decrypt the encrypted content, the decrypted content being stored in an input/output buffer of the receiving device; and
securely using, reading or playing the contents of the input/output buffer of the receiving device, the secret session key having been successfully created and exchanged between the sending and receiving devices without exchanging or transmitting the actual secret session keys therebetween, the secure communication between the sending and receiving devices of encrypted content being maintained until termination of the communication is initiated by at least one of the sending and receiving devices.

22. The computer-readable medium according to claim 21, further comprising:
prior to transmitting the encrypted content, transmitting from the sending device to the receiving device through secured communication the predetermined number of pseudo-random bit data in the random number table to the receiving device having the unique device number and unique user keycode number corresponding to the random number table; and
securely storing in an electronic memory of the receiving device, the predetermined number of pseudo-random bit data received from the sending device, the predetermined number of pseudo-random bit data being stored in association with the device number and the user keycode.

23. The computer-readable medium according to claim 21, further comprising:
providing the receiving device with non-system randomizer software identical to the non-system randomizer software used by the sending device to generate the predetermined number of pseudo-random bit data included in the random number table;
prior to transmission of the encrypted content, transmitting from the sending device to the receiving device, the seed value via secure communication, the seed value corresponding to the pseudo-random bit data in the random number table associated with the unique device number and unique user keycode number of the receiving device;
generating a predetermined number of pseudo-random bit data at the receiving device using the non-system randomizer software and seed value; and
securely storing in an electronic memory of the receiving device, the predetermined number of pseudo-random bit data generated based on the seed value as a random number table associated with the unique device number and the unique user keycode number.

24. The computer-readable medium according to claim 21, further comprising:
providing the receiving device with a plurality of unique secret user keycode numbers assigned thereto;
securely transmitting, from the receiving device to the sending device, the unique device number and one of the plurality of unique user keycode numbers not assigned to a random number table stored at the receiving device;
associating, in the secret index of the sending device, the random number table to the unique device number and the one of the plurality of unique user keycode numbers received from the receiving device;
prior to transmitting the encrypted content, transmitting from the sending device to the receiving device through secured communication the predetermined number of pseudo-random bit data in the random number table to the receiving device having the unique device number and the one of the plurality of unique user keycode numbers corresponding to the random number table; and
securely storing in an electronic memory of the receiving device, the predetermined number of pseudo-random bit data received from the sending device, the predetermined number of pseudo-random bit data being stored in association with the device number and the one of the plurality of unique user keycode numbers.

25. The computer-readable medium according to claim 21, wherein the secret session key is selected as a subset of the predetermined number of pseudo-random bit data of the random number data by identifying the start pointer and the end pointer corresponding to the secret session key using a predetermined algorithm.

26. The computer-readable medium according to claim 21, wherein the secret session key is randomly selected as a subset of the predetermined number of pseudo-random bit data of the random number data by identifying the start pointer and the end pointer corresponding to the secret session key using a random method.

27. The computer-readable medium according to claim 21, wherein transforming the contents of the secret session key properties descriptor buffer in the sending device includes performing an exclusive-or operation between the contents of the secret session key properties descriptor buffer and the unique user keycode number corresponding to the receiving device, and
restoring the contents of the copied mangled secret session key properties descriptor buffer includes performing an exclusive-or operation between the contents of the copied mangled secret session key properties descriptor buffer and the unique user keycode number.

28. The computer-readable medium according to claim 21, wherein transforming the contents of the secret session key properties descriptor buffer includes encrypting the contents of the secret session key properties descriptor buffer using symmetric secret key encryption and the unique user keycode number, and
restoring the contents of the copied mangled secret session key properties descriptor buffer includes decrypting with the symmetric secret key encryption and the unique user keycode number.

29. The computer-readable medium of claim 21, wherein the data to be transmitted by the sending device is streaming data, and each block of the streaming data is stored in the input/output buffer upon transmission of the previously stored block of the streaming data to the receiving device.

30. The computer-readable medium according to claim 29, wherein transforming the contents of the secret session key properties descriptor buffer includes encrypting the contents of the secret session key properties descriptor buffer using symmetric secret key encryption and the unique user keycode number, and
restoring the contents of the copied mangled secret session key properties descriptor buffer includes decrypting with the symmetric secret key encryption and the unique user keycode number.

31. A computer-readable medium storing computer-readable instructions thereon, the computer-readable instructions when executed by a processor, cause the processor to perform a method comprising:
providing a receiving device with a unique device number, a unique user keycode number assigned thereto, and a symmetric secret key encryption algorithm;
providing a sending device with a unique device number, a unique user keycode assigned thereto, a seed value, a symmetric secret key encryption algorithm, and a non-system randomizer software;
transmitting, from the receiving device to the sending device, the unique device number and unique user keycode corresponding to the receiving device;
transmitting, from the sending device to the receiving device, the unique device number and unique user keycode corresponding to the sending device;
generating, at the sending device, a predetermined number of pseudo-random bit data using the seed value, the predetermined number of pseudo-random bit data forming a random number table;
assigning, in a secret index stored in an electronic memory of the sending device, the random number table to unique device number and the unique user keycode number corresponding to the receiving device;
securely storing in the electronic memory of the receiving device, the unique device number and the unique user keycode number corresponding to the sending device;
selecting, at the sending device, a secret session key as a subset of the pseudo-random bit data in the random number table corresponding to the unique device number and unique user keycode number of the receiving device;
selecting, at the sending device, a start pointer and an end pointer corresponding to the subset of the pseudo-random bit data, the start and end pointers defining selected properties of the secret session key including a length and random number table location thereof;
storing the selected properties of the secret session key, the start pointer and the end pointer into a secret session key properties descriptor buffer of the sending device;
copying the secret session key into a secret session key buffer of the sending device using the start and end pointers to locate the secret session key within the random number table, the secret session key corresponding to the selected properties of the secret session key;
encoding, at the sending device, the contents of the secret session key properties descriptor buffer into mangled secret session key properties;
storing in an input/output buffer of the sending device, data to be encrypted and transmitted to the receiving device;
encrypting, at the sending device, the data in the input/output buffer using the symmetric key encryption algorithm and the secret session key stored in the secret session key buffer to generate an encrypted content;
appending, at the sending device, the unique device number and mangled secret session key properties as a header of the encrypted content;
creating a connection between the sending device and the receiving device;
transmitting the encrypted content with the appended header from the sending device to the receiving device;
verifying, at the receiving device, the unique device number in the header of the encrypted content with the unique device number stored in the receiving device to determine whether the receiving device is authorized to decrypt the encrypted content;
extracting, at the receiving device, the mangled secret session key properties when receiving device is authorized to decrypt the encrypted content, the mangled session key properties being stored in a copied mangled secret session key properties descriptor buffer of the receiving device;
restoring the contents of the copied mangled secret session key properties descriptor buffer, the restored secret session key properties corresponding to the secret session key properties at the sending device, the restored session key properties including the selected properties, the start pointer and the end pointer of the secret session key;
utilizing, at the receiving device, at least a subset of the selected properties, the starting pointer and the end pointer to extract the secret session key from a predetermined number of pseudo-random bit data previously stored in the receiving device, the predetermined number of pseudo-random bit data stored in the receiving device corresponding to the predetermined number of pseudo-random bit data stored in the sending device, the extracted secret session key being a duplicate of the secret session key stored in the sending device;
decrypting the encrypted content at the receiving device using the symmetric key encryption algorithm and the extracted secret session key when receiving device is authorized to decrypt the encrypted content, the decrypted content being stored in an input/output buffer of the receiving device;
securely using, reading or playing the contents of the input/output buffer of the receiving device, the secret session key having been successfully created and exchanged between the sending and receiving devices without exchanging or transmitting the actual secret session keys therebetween;
determining, at the receiving device, whether additional communication with the sending device is required based on the contents of the input/output buffer;
encoding, at the receiving device, restored secret session key properties into mangled secret session key properties, and storing the mangled secret session key properties into a mangled secret session key properties descriptor buffer;
storing data to be encrypted and transmitted from the receiving device to the sending device in an input/output buffer of the receiving device;
encrypting, at the receiving device, the data in the input/output buffer using the symmetric key encryption algorithm and the secret session key to generate an encrypted content;
appending, at the receiving device, the unique device number of the sending device and the contents of the mangled secret session key properties descriptor buffer as a header of the encrypted content;
creating a connection between the receiving device and the sending device;
transmitting the encrypted content with the appended header from the receiving device to the sending device;
verifying, at the sending device, the unique device number in the header of the encrypted content with the unique device number stored in the sending device to determine whether the sending device is authorized to decrypt the encrypted content;
extracting, at the sending device, the mangled secret session key properties when the sending device is authorized to decrypt the encrypted content, the mangled session key properties being stored in a copied mangled secret session key properties descriptor buffer of the sending device;
restoring the contents of the copied mangled secret session key properties descriptor buffer, the restored secret session key properties corresponding to the secret session key properties at the receiving device, the restored secret session key properties including the selected properties, the start pointer and the end pointer of the secret session key;
utilizing, at the sending device, at least a subset of the selected properties, the starting pointer and the end pointer to extract the secret session key from a predetermined number of pseudo-random bit data previously stored in the sending device, the predetermined number of pseudo-random bit data stored in the sending device corresponding to the predetermined number of pseudo-random bit data stored in the receiving device, the extracted secret session key being a duplicate of the session key stored in the receiving device;
decrypting the encrypted content at the sending device using the symmetric key encryption algorithm and the extracted secret session key when the sending device is authorized to decrypt the encrypted content, the decrypted content being stored in an input/output buffer of the sending device;
securely using, reading or playing the contents of the input/output buffer of the receiving device, the secret session key having been successfully created and exchanged between the sending and receiving devices without exchanging or transmitting the actual secret session keys therebetween;
repeating all steps above until at least one of the sending device and the receiving device ends communication therebetween.

32. The computer-readable medium according to claim 31, further comprising:
prior to transmitting the encrypted content from the sending device to the receiving device, transmitting from the sending device to the receiving device through secured communication the predetermined number of pseudo-random bit data in the random number table to the receiving device having the unique device number and unique user keycode number corresponding to the random number table; and
securely storing in an electronic memory of the receiving device, the predetermined number of pseudo-random bit data received from the sending device, the predetermined number of pseudo-random bit data being stored in association with the device number and the user keycode.

33. The computer-readable medium according to claim 31, further comprising:
providing the receiving device with non-system randomizer software identical to the non-system randomizer software used by the sending device to generate the predetermined number of pseudo-random bit data included in the random number table;
prior to transmission of the encrypted content, transmitting from the sending device to the receiving device, the seed value via secure communication, the seed value corresponding to the pseudo-random bit data in the random number table associated with the unique device number and unique user keycode number of the receiving device;
generating a predetermined number of pseudo-random bit data at the receiving device using the non-system randomizer software and seed value; and
securely storing in an electronic memory of the receiving device, the predetermined number of pseudo-random bit data generated based on the seed value as a random number table associated with the unique device number and the unique user keycode number,
wherein the seed value is used to transmit encrypted contents from the sending device to the receiving device and to transmit encrypted contents from the receiving device to the sending device.

34. The computer-readable medium according to claim 31, further comprising:
providing the receiving device with a plurality of unique secret user keycode numbers assigned thereto;
securely transmitting, from the receiving device to the sending device, the unique device number and one of the plurality of unique user keycode numbers not assigned to a random number table stored at the receiving device;
associating, in the secret index of the sending device, the random number table to the unique device number and the one of the plurality of unique user keycode numbers received from the receiving device;
prior to transmitting the encrypted content, transmitting from the sending device to the receiving device through secured communication the predetermined number of pseudo-random bit data in the random number table to the receiving device having the unique device number and the one of the plurality of unique user keycode numbers corresponding to the random number table; and
securely storing in an electronic memory of the receiving device, the predetermined number of pseudo-random bit data received from the sending device, the predetermined number of pseudo-random bit data being stored in association with the device number and the one of the plurality of unique user keycode numbers.

35. The computer-readable medium according to claim 31, wherein the secret session key is selected as a subset of the predetermined number of pseudo-random bit data of the random number data by identifying the start pointer and the end pointer corresponding to the secret session key using a predetermined algorithm.

36. The computer-readable medium according to claim 31, wherein the secret session key is randomly selected as a subset of the predetermined number of pseudo-random bit data of the random number data by identifying the start pointer and the end pointer corresponding to the secret session key using a random method.

37. The computer-readable medium according to claim 31, wherein transforming the contents of the secret session key properties descriptor buffer in the sending device includes performing an exclusive-or operation between the contents of the secret session key properties descriptor buffer and the unique user keycode number corresponding to the receiving device,
restoring the contents of the copied mangled secret session key properties descriptor buffer of the receiving device includes performing an exclusive-or operation between the contents of the copied mangled secret session key properties descriptor buffer and the unique user keycode number of the receiving device,
transforming the contents of the secret session key properties descriptor buffer in the receiving device includes performing an exclusive-or operation between the contents of the secret session key properties descriptor buffer and the unique user keycode number corresponding to the sending device, and
restoring the contents of the copied mangled secret session key properties descriptor buffer of the sending device includes performing an exclusive-or operation between the contents of the copied mangled secret session key properties descriptor buffer and the unique user keycode number of the sending device.

38. The computer-readable medium according to claim 31, wherein transforming the contents of the secret session key properties descriptor buffer in the sending device includes encrypting the contents of the secret session key properties descriptor buffer using symmetric secret key encryption and the unique user keycode number of the receiving device,
restoring the contents of the copied mangled secret session key properties descriptor buffer of the receiving device includes decrypting with the symmetric secret key encryption and the unique user keycode number of the receiving device,
transforming the contents of the secret session key properties descriptor buffer in the receiving device includes encrypting the contents of the secret session key properties descriptor buffer using symmetric secret key encryption and the unique user keycode number of the sending device, and
restoring the contents of the copied mangled secret session key properties descriptor buffer of the sending device includes decrypting with the symmetric secret key encryption and the unique user keycode number of the sending device.

39. The computer-readable medium according to claim 31, wherein the data to be transmitted by the sending device is streaming data and each block of the streaming data is stored in the input/output buffer upon transmission of the previously stored block of the streaming data to the receiving device, and
the data to be transmitted by the receiving device is streaming data and each block of the streaming data is stored in the input/output buffer upon transmission of the previously stored block of the streaming data to the sending device.

40. The computer-readable medium according to claim 39, wherein transforming the contents of the secret session key properties descriptor buffer in the sending device includes encrypting the contents of the secret session key properties descriptor buffer using symmetric secret key encryption and the unique user keycode number of the receiving device,
restoring the contents of the copied mangled secret session key properties descriptor buffer of the receiving device includes decrypting with the symmetric secret key encryption and the unique user keycode number of the receiving device,
transforming the contents of the secret session key properties descriptor buffer in the receiving device includes encrypting the contents of the secret session key properties descriptor buffer using symmetric secret key encryption and the unique user keycode number of the sending device, and
restoring the contents of the copied mangled secret session key properties descriptor buffer of the sending device includes decrypting with the symmetric secret key encryption and the unique user keycode number of the sending device.
